(19) United States
(12) Patent Application Publication
(10) Pub. No.: US 2025/0014593 A1
(43) Pub. Date: Jan. 9, 2025

(54) Method and System for Generating an Explainable Prediction of an Emotion Associated With a Vocal Sample

(71) Applicant: National University of Singapore, Singapore (SG)

(72) Inventors: Brian Youliang LIM, Singapore (SG); Wencan ZHANG, Singapore (SG)

(21) Appl. No.: 18/708,633

(22) PCT Filed: Nov. 9, 2022
(86) PCT No.: PCT/SG2022/050815

§ 371 Date: May 9, 2024

(30) Foreign Application Priority Data
Nov. 10, 2021 (SG) 10202112485R

(51) Int. Cl. G10L 25/63; G10L 13/047; G10L 15/06; G10L 25/30

(52) U.S. Cl. CPC G10L 25/63; G10L 13/047; G10L 15/063; G10L 25/30; G10L 2015/0635

(57) ABSTRACT

A method and a system for generating an explainable prediction of an emotion associated with a vocal sample are disclosed. The method includes receiving, by a processing device, a vector representation (z,) of an initial prediction (y0) of the emotion associated with the vocal sample (x), a counterfactual synthetic vocal sample (xY) associated with the vocal sample (x) and an alternate emotion (y) different from the initial prediction (y0) of the emotion, a vector representation (z,) of an emotion prediction (y0) associated with the counterfactual synthetic vocal sample (xy), vocal cue information (cy, cy) associated with the vocal sample (x) and the counterfactual synthetic vocal sample (xY) and attribution explanation information (iVc7) associated with relative importance of the vocal cue information (cy, cy) in prediction of the emotion. The method also includes determining, using the processing device, numeric cue differences (cyy) between the vocal cue information (cy) associated with the vocal sample (x) and the vocal cue information (cy) associated with the counterfactual synthetic vocal sample (xy), generating, using the processing device, cue difference relations information (r\hat{ }) based on the attribution explanation information (iv\hat{ }7), the numeric cue differences (cyy), the vector representation (z,) of the initial prediction (y0) and the vector representation (z,) of the emotion prediction (y0) associated with the counterfactual synthetic vocal sample (xY) using a first neural network (Mr), generating, using the processing device, a final prediction (y) of the emotion based on the numeric cue differences (cyy), the vector representation (z,) of the initial prediction (y0) and the vector representation (z,) of the emotion prediction (y0) associated with the counterfactual synthetic vocal sample (xY) using a second neural network (My), and generating, using the processing device, the explainable prediction of the emotion associated with the vocal sample (x) based on at least the counterfactual synthetic vocal sample (xY), the final prediction (y) of the emotion and the cue difference relations information (r\hat{ }).

### TECHNICAL FIELD

The present invention generally relates to a method and system for generating an explainable prediction of an emotion associated with a vocal sample.

### BACKGROUND ART

There is a need for machine learning models to provide relatable explanations, since people often seek to understand why a puzzling prediction occurred instead of some counterfactual contrast outcome. While current algorithms for contrastive explanations can provide rudimentary comparisons between examples or raw features, these remain difficult to interpret since they lack semantic meaning.

Consider artificial intelligence (AI) based audio prediction which would benefit from relatable explanations. Current explanation techniques for audio typically present saliency maps on audiograms or spectrograms. However, spectrograms are rather technical and ill-suited for lay users or even non-engineering domain experts. Moreover, saliency maps are too simple to merely point to specific regions without explaining why they are important. Furthermore, explaining audio visually is problematic since sound is not visual, and people understand them through relating to concepts or other audio samples. Example-based explanations extract or produce examples for users to compare but this still requires humans to speculate why some examples are similar or different. With applications in smart speakers for the home for smart home and digital assistants for mental health monitoring and affective computing in general, there is a growing need for these AI models to be relatably explainable.

### SUMMARY OF INVENTION

An aspect of the present disclosure provides a method for generating an explainable prediction of an emotion associated with a vocal sample. The method includes receiving, by a processing device, a vector representation of an initial prediction of the emotion associated with the vocal sample, a counterfactual synthetic vocal sample associated with the vocal sample and an alternate emotion different from the initial prediction of the emotion, a vector representation of an emotion prediction associated with the counterfactual synthetic vocal sample, vocal cue information associated with the vocal sample and the counterfactual synthetic vocal sample, and attribution explanation information associated with relative importance of the vocal cue information in prediction of the emotion. The method also includes determining, using the processing device, numeric cue differences between the vocal cue information associated with the vocal sample and the vocal cue information associated with the counterfactual synthetic vocal sample, generating, using the processing device, cue difference relations information based on the attribution explanation information, the numeric cue differences, the vector representation of the initial prediction and the vector representation of the emotion prediction associated with the counterfactual synthetic vocal sample using a first neural network, generating, using the processing device, a final prediction of the emotion based on the numeric cue differences, the vector representation of the initial prediction and the vector representation of the emotion prediction associated with the counterfactual synthetic vocal sample using a second neural network, and generating, using the processing device, the explainable prediction of the emotion associated with the vocal sample based on at least the counterfactual synthetic vocal sample, the final prediction of the emotion and the cue difference relations information.

The step of receiving the counterfactual synthetic vocal sample can include generating, using the processing device, the counterfactual synthetic vocal sample based on the vocal sample and the alternate emotion using a generative adversarial network.

The step of receiving the vocal cue information associated with the vocal sample and the counterfactual synthetic vocal sample can include generating, using the processing device, a contrastive saliency explanation based on the vocal sample, the initial prediction, and the alternate emotion using a visual explanation algorithm, and determining, using the processing device, the vocal cue information associated with the vocal sample based on the vocal sample and the contrastive saliency explanation, and the vocal cue information associated with counterfactual synthetic vocal sample based on the counterfactual synthetic vocal sample and the contrastive saliency explanation.

The vocal cue information can be associated with one or more of a group consisting of: shrillness, loudness, average pitch, pitch range, speaking rate and proportion of pauses.

Another aspect of the present disclosure provides a system for generating an explainable prediction of an emotion associated with a vocal sample. The system can include a processing device configured to receive a vector representation of an initial prediction of the emotion associated with the vocal sample, a counterfactual synthetic vocal sample associated with the vocal sample and an alternate emotion different from the initial prediction of the emotion, a vector representation of an emotion prediction associated with the counterfactual synthetic vocal sample, vocal cue information associated with the vocal sample and the counterfactual synthetic vocal sample, and attribution explanation information associated with relative importance of the vocal cue information in prediction of the emotion. The processing device can also be configured to determine numeric cue differences between the vocal cue information associated with the vocal sample and the vocal cue information associated with the counterfactual synthetic vocal sample, generate cue difference relations information based on the attribution explanation information, the numeric cue differences, the vector representation of the initial prediction and the vector representation of the emotion prediction associated with the counterfactual synthetic vocal sample using a first neural network, generate a final prediction of the emotion based on the numeric cue differences, the vector representation of the initial prediction and the vector representation of the emotion prediction associated with the counterfactual synthetic vocal sample using a second neural network, and generate the explainable prediction of the emotion associated with the vocal sample based on at least the counterfactual synthetic vocal sample, the final prediction of the emotion and the cue difference relations information.

The processing device can be configured to generate the counterfactual synthetic vocal sample based on the vocal sample and the alternate emotion using a generative adversarial network.

The processing device can be configured to generate a contrastive saliency explanation based on the vocal sample, the initial prediction, and the alternate emotion using a visual explanation algorithm, and determine the vocal cue information associated with the vocal sample based on the vocal sample and the contrastive saliency explanation, and the vocal cue information associated with counterfactual synthetic vocal sample based on the counterfactual synthetic vocal sample and the contrastive saliency explanation.

The vocal cue information can be associated with one or more of a group consisting of: shrillness, loudness, average pitch, pitch range, speaking rate and proportion of pauses.

Another aspect of the present disclosure provides a method for training a neural network. The method can include receiving, by a processing device, a training vector representation of the emotion associated with the vocal sample, a training vector representation of an emotion prediction associated with a counterfactual synthetic vocal sample, the counterfactual synthetic vocal sample associated with the vocal sample and an alternate emotion different from the emotion, training numeric cue difference information associated with the vocal sample and the counterfactual synthetic vocal sample and a reference emotion associated with the vocal sample. The method can also include generating, using the processing device, an emotion prediction associated with the vocal sample based on the training numeric cue difference information, the training vector representation of the emotion associated with the vocal sample and the training vector representation of the emotion prediction associated with the counterfactual synthetic vocal sample using the neural network, calculating, using the processing device, a classification loss value based on differences between the emotion prediction and the reference emotion, and updating, using the processing device, the neural network to minimise the classification loss value.

The method can further include calculating, using the processing device, attribution explanation information with layer-wise relevance propagation of the neural network, the attribution explanation information associated with relative importance of the vocal cue information in prediction of the emotion.

Another aspect of the disclosure provides a method for training a neural network. The method includes receiving, by a processing device, a training vector representation of the emotion associated with the vocal sample, a training vector representation of an emotion prediction associated with a counterfactual synthetic vocal sample, the counterfactual synthetic vocal sample associated with the vocal sample and an alternate emotion different from the emotion, training numeric cue difference information associated with the vocal sample and the counterfactual synthetic vocal sample, training attribution explanation information associated with relative importance of the vocal cue information in prediction of the emotion, and reference cue difference relations information associated with the vocal sample and the counterfactual synthetic vocal sample. The method can also include generating, using the processing device, cue difference relations information based on the training attribution information, the training numeric cue differences, the training vector representation of the initial prediction and the training vector representation of the emotion prediction associated with the counterfactual synthetic vocal sample using the neural network, calculating, using the processing device, a classification loss value based on differences between the cue difference relations information and the reference cue difference relations information, and updating, using the processing device, the neural network to minimise the classification loss value.

The vocal cue information can be associated with one or more of a group consisting of: shrillness, loudness, average pitch, pitch range, speaking rate and proportion of pauses.

Another aspect of the present disclosure provides a system for training a neural network. The system can include a processing device configured to receive, a training vector representation of the emotion associated with the vocal sample, a training vector representation of an emotion prediction associated with a counterfactual synthetic vocal sample, the counterfactual synthetic vocal sample associated with the vocal sample and an alternate emotion different from the emotion, training numeric cue difference information associated with the vocal sample and the counterfactual synthetic vocal sample, and a reference emotion associated with the vocal sample. The processing device can be configured to generate an emotion prediction associated with the vocal sample based on the training numeric cue difference information, the training vector representation of the emotion associated with the vocal sample and the training vector representation of the emotion prediction associated with the counterfactual synthetic vocal sample using the neural network, calculate a classification loss value based on differences between the emotion prediction and the reference emotion, and update the neural network to minimise the classification loss value.

The processing device can be configured to calculate attribution explanation information with layer-wise relevance propagation of the neural network, the attribution explanation information associated with relative importance of the vocal cue information in prediction of the emotion.

Another aspect of the disclosure provides a system for training a neural network. The system can include a processing device configured to receive, a training vector representation of the emotion associated with the vocal sample, a training vector representation of an emotion prediction associated with a counterfactual synthetic vocal sample, the counterfactual synthetic vocal sample associated with the vocal sample and an alternate emotion different from the emotion, training numeric cue difference information associated with the vocal sample and the counterfactual synthetic vocal sample, training attribution explanation information associated with relative importance of the vocal cue information in prediction of the emotion, and reference cue difference relations information associated with the vocal sample and the counterfactual synthetic vocal sample. The processing device can also be configured to generate cue difference relations information based on the training attribution information, the training numeric cue differences, the training vector representation of the initial prediction and the training vector representation of the emotion prediction associated with the counterfactual synthetic vocal sample using the neural network, calculate a classification loss value based on differences between the cue difference relations information and the reference cue difference relations information, and update the neural network to minimise the classification loss value.

The vocal cue information can be associated with one or more of a group consisting of: shrillness, loudness, average pitch, pitch range, speaking rate and proportion of pauses.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1A shows an explainable artificial intelligence (XAI) perceptual processing framework for relatable explainable AI.

FIG. 1B shows a table listing example vocal cues used to characterise vocal samples for emotion recognition.

FIG. 2A shows an example modular architecture of a Relatable Explanation Network (RexNet) with relatable contrastive explanations to explain the prediction of emotion y from input voice x, in accordance with embodiments of the invention. Each module is numbered to match the sequence of the perceptual process described in FIG. 1. Black arrows indicate feedforward activations. Grey arrows indicate backpropagation during training. The base CNN model M is denoted with a trapezium block to represent its function as an encoder. The StarGAN generator G_{*GAN} is represented as an encoder-decoder take input x and output \tilde{x}^{γ} with the same shape. [symbol] _{c} is a heuristic model, and Mᵣ and M_{y} are sub-models with only fully-connected layers. Mᵣ is a relationship threshold estimator which converts numeric difference to categorical relationship (lower, similar, higher). The model is trained on 2D spectrograms. For illustrative simplicity, the audio data is represented in its 1D audio waveform.

FIG. 2B shows a schematic diagram of an exemplary system for generating an explainable prediction of an emotion associated with a vocal sample, in accordance with embodiments of the invention.

FIG. 2C shows a method for generating an explainable prediction of an emotion associated with a vocal sample, in accordance with embodiments of the invention.

FIG. 2D shows a method for training a neural network, in accordance with embodiments of the invention.

FIG. 2E shows another method for training a neural network, in accordance with embodiments of the invention.

FIG. 3 shows a schematic diagram of an exemplary generative adversarial model used to generate counterfactual synthetics. Dark arrows indicate feedforward activations. Grey arrows indicate backpropagation during training.

FIG. 4A shows a conceptual illustration of the benefit of using counterfactual synthetics for comparison. Different example types (exemplar, counterfactual, prototype) have varying distances from the target instance.

FIG. 4B shows a table listing vocal cues for each emotion relative to average levels. Values indicate the absolute cues.

FIG. 4C shows a table listing vocal cues for target emotions compared to another emotion (happy). Values indicate the contrastive cues.

FIG. 5A shows an exemplary user interface used to show vocal emotion prediction and explanation with all contrastive explanation types.

FIG. 5B shows a table listing evaluation results of model prediction performance and explanation correctness for RexNet and baseline models (Random, Base CNN). RexNet models compared include the full model, and one trained with Counterfactual Samples (C.Samples) without StarGAN used in user studies. Grey numbers calculated by definition, instead of from empirical results. * same as base CNN model.

FIGS. 6A and 6B show results of summary statistics of user labelling confidence (of correct label) and cue difference understanding.

FIGS. 7A to 7F show results of inferential statistical analysis of the impact of relatable explanations on the AI-assisted emotion recognition task. Significant results are reported with dotted lines (p<0.0001), unless otherwise stated. XAI Types are explainable AI interfaces with one or more explanation types: Prediction only, Contrastive Saliency, Counterfactual Sample (C.factual), and Contrastive Cues.

FIG. 8 shows distribution of cue values for different emotions and the average across all voice clips. Values calculated from the RAVDESS dataset. Differences were used to calculate cue difference relations. Grey line indicates average value.

FIG. 9 shows an example tutorial to interpret the “balls and bins” question.

FIG. 10 shows an example tutorial on the system's prediction and screening question to check users' audio equipment.

FIG. 11 shows an example tutorial on the contrastive saliency explanation and screening question to interpret it.

FIG. 12 shows an example tutorial on the counterfactual sample explanation.

FIG. 13 shows an example tutorial on the contrastive cue explanation and screening question to check users' understanding about vocal cues.

FIG. 14 shows an example main study per-voice trial after revealing the system's prediction and XAI information (Post-XAI).

FIG. 15 shows an example main study per-voice trial with the system's prediction.

FIG. 16 shows an example main study per-voice trial with the system's prediction and contrastive saliency.

FIG. 17 shows an example main study per-voice trial with the system's prediction and comparison voice.

FIG. 18 shows an example main study per-voice trial with the system's prediction, comparison voice and vocal cues.

FIG. 19 shows an example main study per-voice trial with the system's prediction, contrastive saliency, comparison voice and vocal cues.

FIG. 20 shows an example main study per-voice trial after revealing the system's prediction and XAI information (Post-XAI).

FIG. 21 shows a table listing statistical analysis of responses due to effects (one per row), as linear mixed effects models with random effects, fixed effects, and their interaction effect. F and p values indicate ANOVA tests and R² indicate model goodness-of-fit.

FIG. 22 shows a schematic diagram of an example of a computing device used to realise the system of FIG. 2B.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilising terms such as “associating”, “calculating”, “comparing”, “determining”, “forwarding”, “generating”, “identifying”, “including”, “inserting”, “modifying”, “receiving”, “replacing”, “scanning”, “transmitting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialised apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

The term “configured to” is used in the specification in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

### Overview

There is a need for machine learning models to provide contrastive explanations since people often seek to understand why a puzzling prediction occurred instead of some counterfactual contrast outcome. Current algorithms for contrastive explanations provide rudimentary comparisons between examples or raw features. However, these remain difficult to interpret, since they lack semantic meaning. The explanations must be more relatable to other concepts, hypotheticals, and associations. Taking inspiration from perceptual process in cognitive psychology, embodiments of the present invention provide an explanation artificial intelligence (XAI) Perceptual Processing framework and Relatable Explanation Network (RexNet) model for relatable explainable AI with Contrastive Saliency, Counterfactual Synthetic, and Contrastive Cues explanations. The application of vocal emotion recognition is investigated, and a modular multi-task deep neural network to predict and explain emotions from speech is implemented. From qualitative think-aloud and quantitative controlled studies, varying usage and usefulness across the contrastive explanations is found. Embodiments of the present invention can provide insights into the provision and evaluation of relatable contrastive explainable AI for perception applications.

With the increasing availability of data, deep learning-based artificial intelligence (AI) has achieved strong capabilities in computer vision, natural language processing, and speech processing. However, their complexity limits their use in real-world applications due to the difficulty of understanding them. To address this, much research has been conducted on explainable artificial intelligence (XAI) to develop new XAI algorithms and techniques, understand user needs and evaluate their helpfulness on users.

Despite the myriad XAI techniques, many of them remain difficult for people to understand. This is due to the lack of human-centered design and consideration. Contrastive reasoning has been identified as a particular reason that people ask for explanation, e.g. “one does not explain events per se, but that one explains why the puzzling event occurred in the target cases but not in some counterfactual contrast case.” [Denis J Hilton, Conversational processes and causal explanation, Psychological Bulletin 107, 1 (1990), 65]. The present disclosure further argues that explanations lack relatability to familiar concepts that people are familiar with, and therefore they seem too low-level technical and not semantically meaningful. Existing XAI techniques for contrastive explanations remain unrelatable, hence such explanations have limited human interpretability. Embodiments of the present invention seek to address the aforementioned shortcomings by extending the framing of relatable explanations beyond contrastive explanations to include saliency, counterfactuals, and cues.

Audio prediction is a problem space in dire need of relatable explanations. Much research on XAI techniques focuses on structured data with semantically meaningful features, or images that are intuitively visual. Indeed, most explanations are visualised (e.g. even attribution explanations on words in sentences rely on visual highlighting). Current explanation techniques for audio typically present saliency maps on audiograms or spectrograms. However, spectrograms are rather technical and ill-suited for lay users or even non-engineering domain experts. Moreover, saliency maps are too simple to merely point to specific regions without explaining why they are important. Explaining audio visually is also problematic since sound is not visual and people understand them through relating to concepts or other audio samples. While example-based explanations can extract or produce examples for users to compare, these still require humans to speculate why some examples are similar or different. With applications in smart speakers for the home for smart home, and affective computing in general, there is a growing need for AI models to be relatably explainable. Embodiments of the present invention seek to address these issues by explaining audio predictions in relation to other concepts, counterfactual examples, and associated cues. The present disclosure also discusses the use case of explainable vocal emotion recognition to concretely propose solutions and evaluations.

Not only should explanations be semantically meaningful, but the way the explanations are generated or the way the AI “thinks” should be human-like to earn people's trust. The present disclosure draws upon theories of human cognition to understand why and how people relate concepts, information, and data. The present disclosure frames relatable explanations with the Perceptual Process disclosed in Edward C. Carterette and Morton P. Friedman (Eds.). 1978. Perceptual processing. Academic Press, New York, which describes how people select, organize, and interpret information to make a decision. Corresponding to these stages, an explainable artificial intelligence (XAI) Perceptual Processing Framework is disclosed with modular explanations for Contrastive Saliency, Cues, and Counterfactual Synthetics with Contrastive Cues, respectively. The framework is implemented as a Relatable Explanation Network (RexNet), which is a deep learning model with modules for each explanation type. The present disclosure also evaluates the explanations with a modelling study, a qualitative think-aloud study and a quantitative controlled study to investigate their usage and impact on decision performance and trust perceptions. RexNet has been found to have improved prediction performance and reasonable explanations. Participants appreciated the diversity of explanations; and participants benefited from Counterfactual and Cues explanations.

Embodiments of the present invention address the challenge that explanations need to be relatable is addressed and its applicability to an audio prediction task (vocal emotion recognition) is studied. Embodiments of the present invention provide (i) a framework for relatable explanations inspired from theories in human cognition, (ii) RexNet model with multiple relatable explanation techniques (Contrastive Saliency, Counterfactual Synthetic, Contrastive Cues), (iii) relatable explanations for audio prediction tasks and (iv) evaluation findings of usage and impact of various relatable explanations. Embodiments of the present invention can provide the following advantages. Relatable explanations for audio prediction tasks (vocal emotion recognition) can enable more human interpretable explanations of unstructured data (e.g., images, audio) in semantically meaningful way, and allow more stakeholders to understand AI. Embodiments of the present invention can also provide non-visual, verbal explanations for audio predictions, e.g., explanations that can be used by smart speakers without screen displays, and can provide semantically meaningful explanations of emotion in speech, which can be used for more insightful automatic monitoring of stress, mental health, user engagement, etc. It can be appreciated that the explanation method is generalizable beyond vocal emotion or other audio-based prediction models and can apply to image-based or other AI-based perception predictions.

### Explainable AI Techniques

Various explainable AI techniques are introduced in the following sections. Their shortcomings, particularly how they lack human-centeredness despite ongoing human-computer interaction (HCI) research, are discussed. The background on speech emotion recognition is described and their lack of explainability is highlighted.

Much research has been done to develop explainable AI (XAI) for improving models' transparency and trustworthiness. An intuitive approach is to point out which features are most important. Attribution explanations do this by identifying importance using gradients, ablation, activations or decompositions. In computer vision, attributions take the form of saliency maps. Explaining by referring to key examples is another popular approach. This includes simply providing arbitrary samples of specific classes, cluster prototypes or criticisms, or influential training set instances. However, users typically have expectations and goals when asking for explanations. When an expected outcome does not happen, users would ask for contrastive explanations. A straightforward approach would be to find the attribution differences between the actual (fact) and expected (foil) outcomes. However, this can be naive because users are truly asking for what differences in feature values, not attributions, would lead to the alternative outcome. That is a counterfactual explanation. Furthermore, to anticipate a future outcome or prevent an undesirable one, users could ask for counterfactual explanations. Indeed, contrastive explanations are often conflated with counterfactual explanations in the research literature. Such explanations suggest the minimum changes that the current case needs to change to achieve the desired outcome. Trained decision structures, such as local foil trees, Bayesian rule lists, or structural causal models can also serve as counterfactual explanations. Though typically explained in terms of feature values or anchor rules, techniques have been developed to synthesize counterfactuals of unstructured data (e.g., images and text). Embodiments of the present invention employ the synthesis approach to generate counterfactuals of audio data.

In simple terms, these explanation types are defined in an intelligibility taxonomy as Why (Attribution), Why Not (Contrastive), and How To (Counterfactual). While many of these XAI techniques have been independently developed or tested, their usage is disparate. Embodiments of the present invention unifies these techniques in a common framework and integrate them in a single machine learning model.

### Human-Centered Explainable AI

A large gap between XAI algorithms and human-centered research has been found. To close this gap, human-computer interaction (HCI) researchers have been active in evaluating the various benefits (or lack thereof) of XAI. Empirical works have studied effects on understanding and trust, uncertainty, cognitive load, types of examples, etc. While studies have sought to determine the “best” explanation type, there is a benefit of reasoning with multiple explanations. Embodiments of the present invention provides a unified framework to provide multiple relatable explanations. The human-centered explanation requirements disclosed herein is determined by studying literature on human cognition, which is epistemologically similar to works grounded in philosophy and psychology, and unlike empirical approaches to elicit user requirements. Furthermore, existing literature focus on explaining higher-level AI-assisted reasoning tasks, rather than perception tasks that are commonplace. This has implications on the depth of explanations to provide, which is discussed in the following sections.

### Speech Emotion Recognition

Deep learning approaches proliferate research on automatic speech emotion recognition. Leveraging the intrinsic time-series structure of speech data, recurrent neural network (RNN) models with attention mechanism have been developed to capture transient acoustic features to understand contextual information. Employing popular techniques from the computer vision domain, audio data can be treated as 1-dimensional arrays or converted to a spectrogram as a 2-dimensional image. Convolutional neural networks (CNNs) can then extract salient features from these audiograms or spectrograms. Current approaches improve performance by combining CNN and RNN, or modelling with multiple modalities. The Relatable Explanation Network (RexNet) model, in accordance with embodiments of the disclosure, starts with a base CNN model to leverage many more XAI techniques available to CNNs than RNNs. The approach is modular and can be generalised to state-of-the-art seeding, evolutionary growth, and reseeding (SER) models.

### Model Explanations of Audio Predictions

Due to the availability of image data and intuitiveness of vision, much XAI research has focused on image prediction tasks; in contrast, few techniques have been developed for audio prediction tasks. Many techniques exploit CNN explanations by generating a saliency map on the audio spectrogram. Other explanations focus on model debugging by visualising neuron activations, or as feature visualising (for image kernels). While embodiments of the present invention leverage on saliency maps as one explanation due to its intuitive pointing, saliency maps are augmented with multiple relatable explanations to provide a more human interpretable explanations of unstructured data in semantically meaningful way. Other than explaining the model behaviour post-hoc, another approach is to make the model more interpretable and trustworthy by constraining the trained model with domain knowledge, such as with voice-specific parametric convolutional filters. The approach in accordance with embodiments of the invention, with modular explanations of specific types, follows a similar objective.

### Intuition and Conceptual Overview

To improve the trustworthiness of model predictions, models should provide explanations that are relatable and human-like. Thus, theories of human perception and cognition are used to define the explainable AI techniques employed herein. The framework and explanation approach is applied to the use case of vocal emotion recognition. In the following sections, background theories from cognitive psychology and research on vocal emotion prosody which are relevant to the approach and application use case are discussed.

### Perceptual Processing

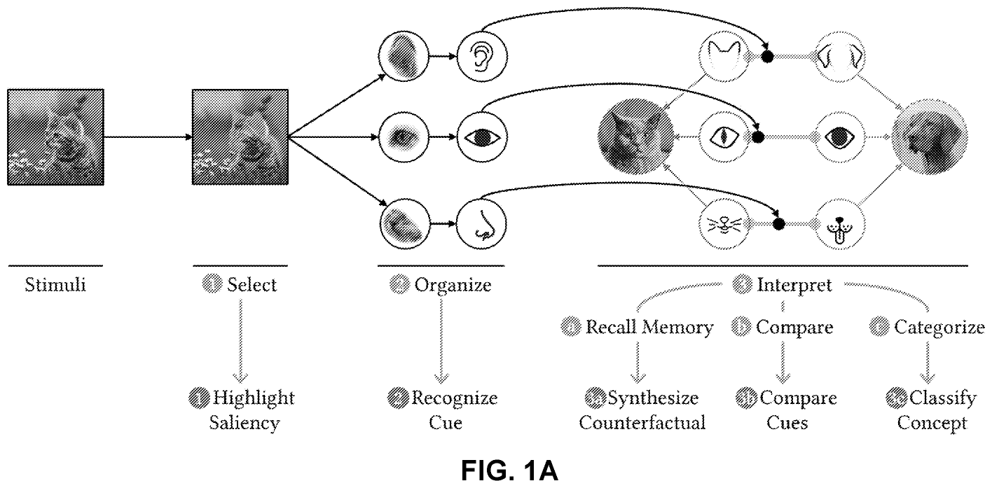

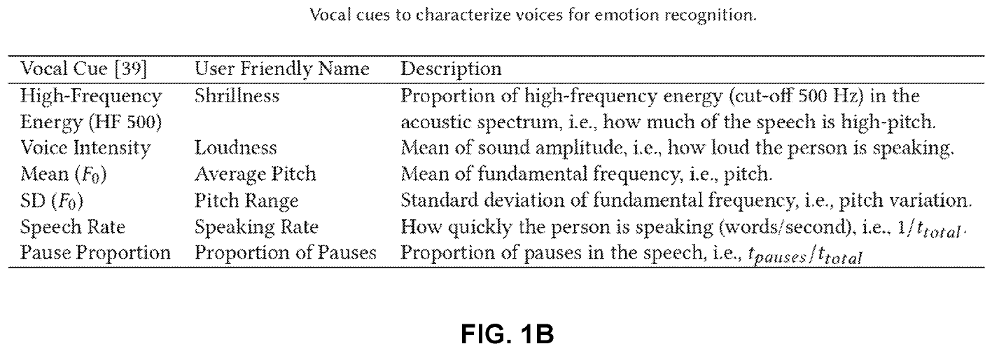

The perceptual process defines three basic stages for how humans perceive and understand stimuli: selection, organization, and interpretation. FIG. 1A illustrates these stages for the case of visually perceiving a cat and relates them to the technical approach disclosed herein, in accordance with embodiments of the invention. FIG. 1A shows an explainable artificial intelligence (XAI) perceptual processing framework for relatable explainable AI. Taking inspiration from the human perceptual process to select, organize, and interpret stimuli, corresponding stages for AI to highlight saliency, recognize cues, and interpret categories (to synthesize counterfactuals, compare cues, classify concepts) are disclosed. For visual clarity, the use case for visual perception of recognising a cat instead of a dog is discussed, although vocal emotion recognition is used for the prediction task and user studies.

With reference to FIG. 1A, when sensory stimuli (e.g., light rays or audio vibrations) reach the senses, 1) the human brain first selects only a subset of the information to focus attention. This is equivalent to highlighting salient regions in an image. 2) The next stage organizes the salient regions into meaningful cues. For the case of a face, these would include recognising the ears, eyes, and nose. 3) Finally, the brain interprets these lower-level cues towards higher-level concepts. In this example, with reference to FIG. 1A, the face cues are used to recognize the animal by: a) recalling from long-term memory the concepts of cat and dog, and their respective cues, b) compare whether each element is closer to the cat or dog version (FIG. 1A uses a slider paradigm for illustration), and c) categorize the concept with the smallest difference. The perceptual processing framework disclosed herein aligns with the model for processing vocal emotional prosody disclosed in (i) Marc D Pell and Sonja A Kotz. 2011, On the time course of vocal emotion recognition, PLoS One 6, 11 (2011), e27256 and (ii) Annett Schirmer and Sonja A Kotz. 2006, Beyond the right hemisphere: brain mechanisms mediating vocal emotional processing, Trends in cognitive sciences 10, 1 (2006), 24-30, which describe stages for “extracting sensory/acoustic features, detecting meaningful relations, conceptual processing of the acoustic patterns in relation to emotion-related knowledge held in long-term memory”.

In particular, people categorize concepts by mentally recalling examples and comparing their similarities. These examples may be prototypes or exemplars. With Prototype Theory, people summarize and recall average examples, but these may be quite different from the observed case being compared. With Exemplar Theory, people memorize and recall specific examples, but this does not scale with inexperienced cases. Instead, people can imagine new cases that they have never experienced. Moreover, rather than tacitly comparing some ill-defined difference between the examples, people make comparisons by judging similarities or differences along dimensions (cues). Categorization can then be done systematically with proposition rules or intuitively, with either sometimes being more effective.

A technical approach using the aforementioned framework is disclosed. The technical approach includes contrastive explanation types to align with each stage of perceptual processing: 1) highlight saliency, 2) recognize cues, 3a) synthesize counterfactual, 3b) compare cues, and 3c) classify concept. Cue differences are presented as rules and an embedding for emotions to represent intuition is leveraged (described later).

### Vocal Emotion Prosody

People recognize vocal emotions based on various vocal stimulus types and prosodic attributes}, such as verbal and non-verbal expressions (e.g., laughs, sobs, screams), and lexical (words) information. In the present disclosure, focus on verbal cues identified in FIG. 1B are discussed. FIG. 1B shows a table listing example vocal cues used to characterise vocal samples for emotion recognition. These vocal cues are about how words are spoken, rather than the words themselves (lexical information). People's ability to index vocal emotion categories by the pattern of cues to identify cue differences between different emotions are used in the present model explanation. In summary, for the prediction application, the concept to predict is emotion, cues are vocal cues for emotion prosody, cue differences support dimensional comparisons, and saliency is in terms of phonemes or pauses between them.

### Exemplary Embodiments

An interpretable deep neural network model to predict vocal emotions and provide relatable contrastive explanations is disclosed. In the following sections, the base prediction model and specific modules for explainability are described.

### Base Prediction Model for Vocal Emotion Recognition

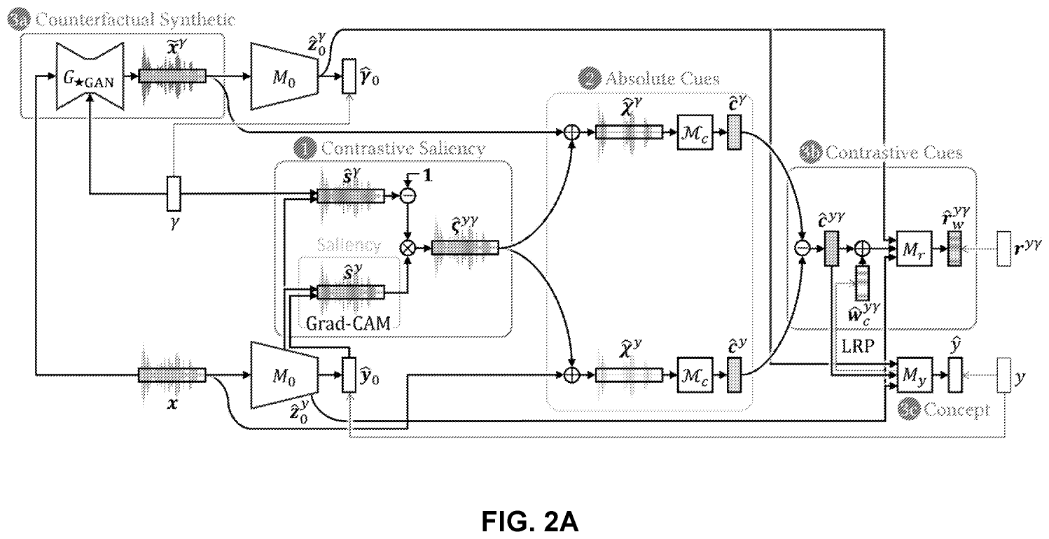

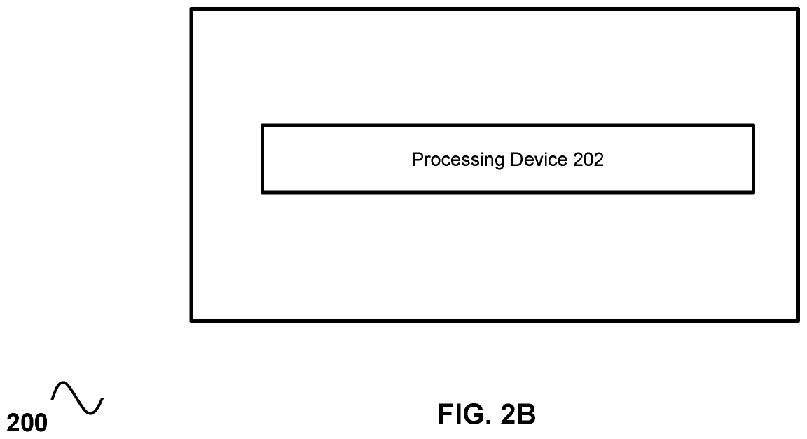

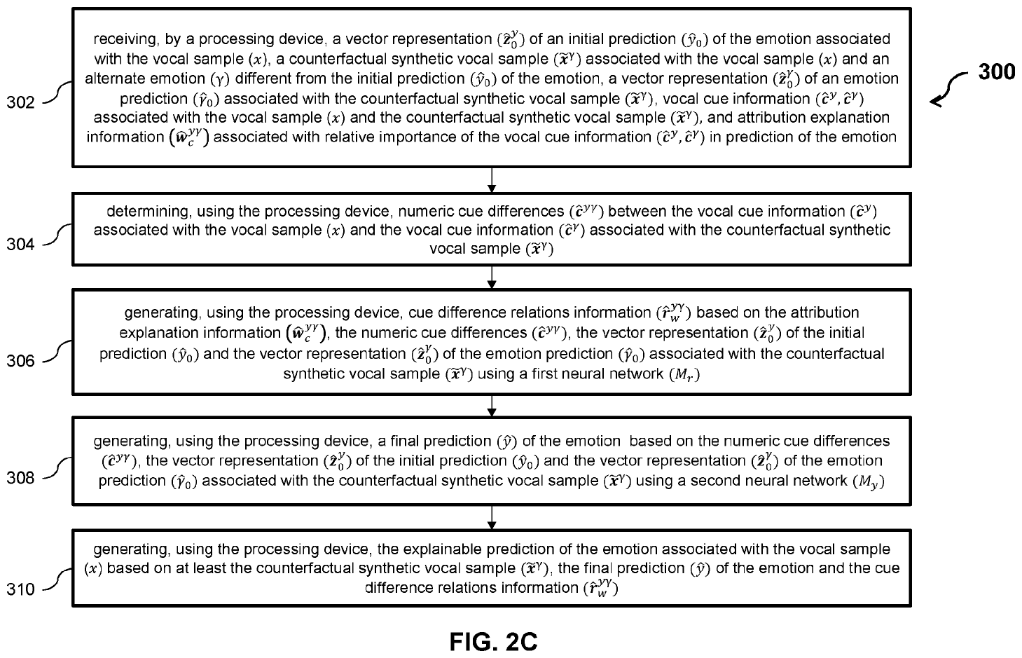

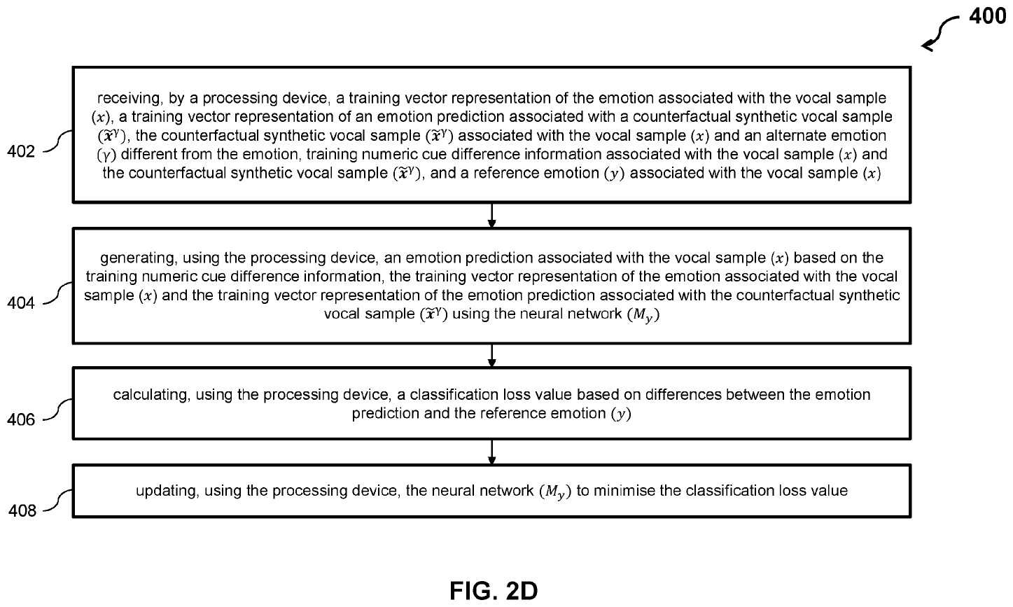

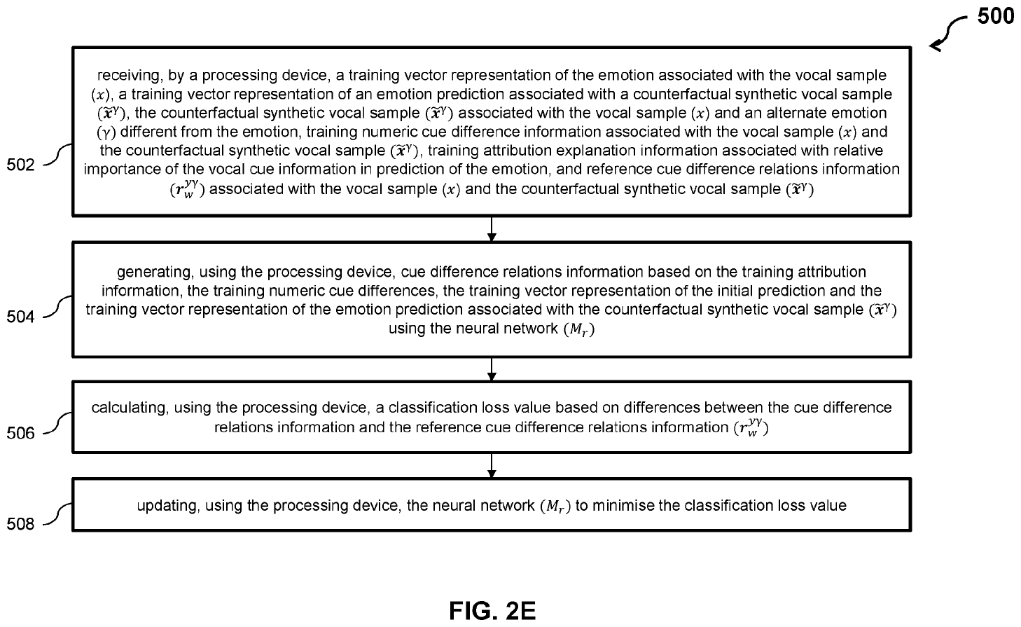

A vocal emotion classifier is trained on the Ryerson Audio-Visual Database of Emotional Speech and Song (RAVDESS) dataset with 7356 audio clips of 24 voice actors (50% female) reading fixed sentences with 8 emotions (neutral, calm, happy, fearful, surprised, sad, disgust, angry). Each audio clip was 2.5-3.5 seconds long, and we padded or cropped them to a fixed 3.0 s. Each audio file is parsed to a time-series array of 48 k readings (i.e., 16 kHz sampling rate), and pre-processed it to obtain a mel-frequency spectrogram with 128 frequency bins, 0.04 s window size, and 0.01 s overlap. Treating the spectrogram as a 2D image, a convolutional neural network (CNN) is trained. In an exemplary embodiment, a CNN with 3 convolutional blocks and 2 fully connected layers is trained. Cross-entropy loss for multi-class classification is used. The base CNN model M₀ takes audio input x to predict an emotion ŷ₀ (see lower left of FIG. 2A, which shows an example modular architecture of a Relatable Explanation Network (RexNet) with relatable contrastive explanations to explain the prediction of emotion y from input voice x, in accordance with embodiments of the invention).

### RexNet: Relatable Explanation Network

A Relatable Explanation Network (RexNet) is disclosed. The Relatable Explanation Network (RexNet) provides relatable explanations for contrastive explainable AI. The base model is extended with multiple modules to provide three relatable contrastive explanations (see FIG. 2A). These comprise non-contrastive and contrastive explanations. The whole architecture can be understood in terms of a chain of dependencies. These are discussed in reverse starting with the goal. Ultimately, the goal is to explain the prediction with descriptive contrastive cues. This requires a counterfactual “foil” to compare the target “fact” with, therefore, an example is required for comparison. When making a comparison, not all stimuli are relevant for interpretation, hence, salient segments are selected. For example, noticing a flower in a photo of a pet is irrelevant to identifying whether an animal is a dog or cat. In summary, the interpretable prediction approach disclosed herein has the following steps:
1. Highlight salient segments
   i. Predict emotion concept as initial estimation
   ii. Keep embedding (represents previous estimation) for final classification
   iii. Explain with contrastive saliency using discounted Gradient-weighted Class Activation Mapping (Grad-CAM). Grad-CAM is disclosed in Ramprasaath R Selvaraju et. al., 2017, Grad-CAM: Visual explanations from deep networks via gradient-based localization, in Proceedings of the IEEE international conference on computer vision, 618-626.
2. Describe segments
   i. Infer associated cues
3a. Generate counterfactual exemplar for each alternative concept
   i. Generate counterfactual synthetic using a generative adversarial network for vocal samples (StarGAN-VC). StarGAN-VC is disclosed in Hirokazu Kameoka et. al., 2018, StarGAN-VC: Non-parallel many-to-many voice conversion using star generative adversarial networks, in 2018 IEEE Spoken Language Technology Workshop (SLT), IEEE, 266-273.
3b. Compare cue differences between target case and each exemplar
   i. Calculate cue differences weighted by saliency
   ii. Classify cue difference relations with cue differences and embedding for target and contrast concepts.
3c. Classify concept fully
   i. Predict concept using inputs: cue differences of all counterfactuals+embedding (initial estimation)
   ii. Explain final concept with attributions for cue differences using layer-wise relevance propagation (LRP). LRP is disclosed in Sebastian Bach et. al., 2015, On pixel-wise explanations for non-linear classifier decisions by layer-wise relevance propagation, PloS one 10, 7 (2015), e0130140.
      In the following subsections, each module for specific contrastive explanations is described.

### RexNet: Contrastive Saliency

Saliency maps are very popular to explain predictions on images since they intuitively highlight which pixels the model considers important for the predicted outcome. For spectrograms or time-series data, they can also identify which frequencies or time periods are most salient. However, they have limited interpretability since they merely point to raw pixels but do not further elaborate on why those pixels were important. For time-series data, highlighting on a spectrogram remains uninterpretable to non-technical users, since many are not trained to read spectrograms. Furthermore, some salient pixels may be important across all prediction classes, and thus be less uniquely relevant to the specific class of interest. For example, a saliency map to predict emotions from faces may always highlight the eyes regardless of emotion. To address the issue of saliency lacking semantic meaningfulness, associative cues, which will described later, are introduced. The need for more specific saliency is addressed with a discounted saliency map to produce contrastive saliency. This retains some importance of globally important pixels, unlike current methods that simply subtract a saliency map of one class from that of another class. Unlike approaches which identified pertinent positives and negatives for more precise contrastive explanations by perturbing features, the approach in accordance with embodiments of the invention calculates based on feature activations.

Two forms of contrastive saliency are defined: pairwise and total. Pairwise contrastive saliency highlights pixels that are important for predicting class y but discounts pixels that are also important for alternative class γ. The saliency map with Grad-CAM (i.e. a visual explanation algorithm) is implemented and the class activation map is defined for class y as s^{y}. The pairwise contrastive saliency between target class y and foil class γ is thus:

$${ς}^{y γ} = {λ}^{y γ} ⊙ {s}^{y}$$

where λ^{yγ}=(1−s^{γ}) indicates the discount factors for all pixels due to their attributions to class γ, 1 is a matrix of all ones, and ⊙ is the Hadamard operator for pixel-wise multiplication. To identify important pixels for class y but not any other class, total contrastive is defined as:

$${ς}^{y} = {λ}^{y} ⊙ {s}^{y}$$

where λ^{y}=Σ_{γ∈C\y}(1−s^{γ})/|C−1| indicates the discount factors across all alternative classes.

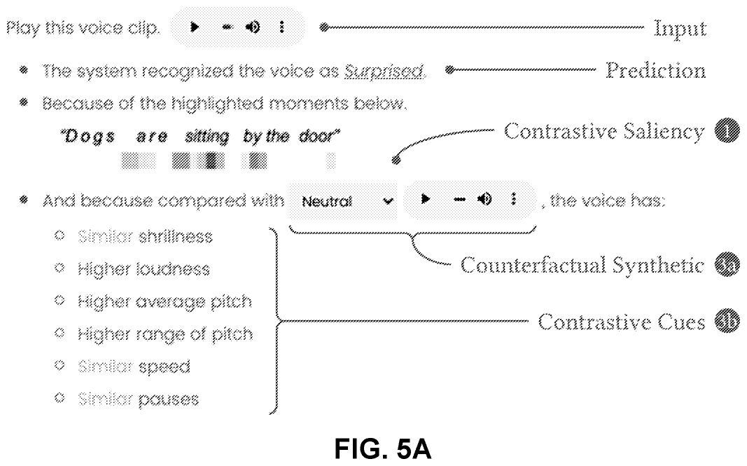

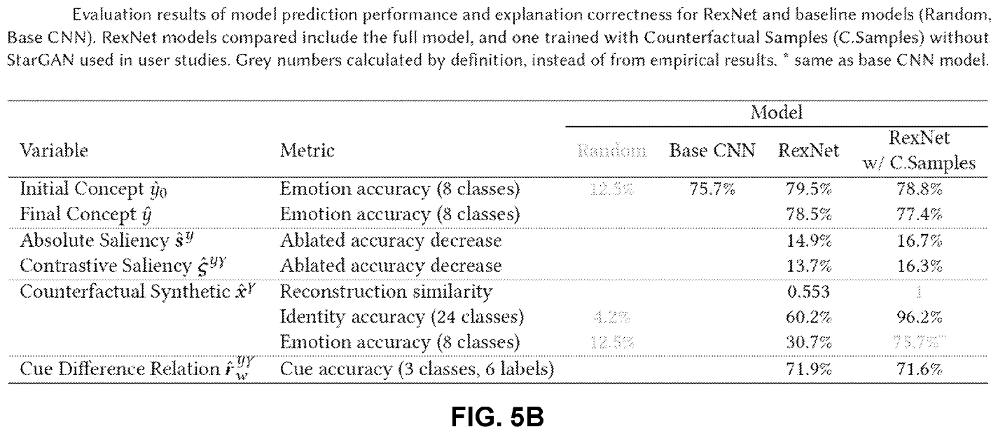

In RexNet, the saliency explanation is calculated from the initial emotion classifier M₀ predicting an initial emotion concept ŷ₀. Contrastive saliency for audio is presented using a 1D saliency bar aligned to words in the speech (see FIG. 5A, which shows an exemplary user interface used to show vocal emotion prediction and explanation with all contrastive explanation types). The saliency bar aggregates saliency in the spectrogram across frequencies per time bin. This is more accessible for lay people to understand since it avoids using spectrograms or audiograms (audio waveforms), which may be too technical.

### RexNet: Counterfactual Synthetic

Embodiments of the present invention seek to create a counterfactual example that is similar to the target instance x which is classified as class y, but with sufficient differences to be classified as another class γ. Current counterfactual methods focus on structured (tabular) data by minimising changes to the target instance or identifying anchor rules, but this is not possible for unstructured data (e.g., images, sounds). Rather, drawing from data synthesis with Generative Adversarial Networks (GANs) and style transfer (domain adaptation) methods, embodiments of the present invention provide explanations with counterfactual synthetics by “re-styling” the original target instance x such that it is classified as another class γ.

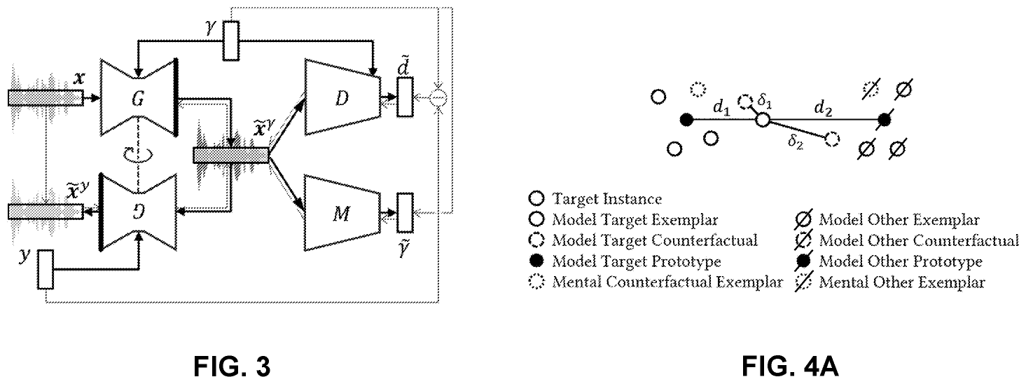

For the application of vocal emotion recognition, embodiments of the present invention aim to change the emotion of the speech audio while retaining the original words and identity. Using StarGAN-VC (an extension of StarGAN for voice data), embodiments of the present invention synthesize a counterfactual instance that is similar to the original instance, but with a different class (see FIG. 3, which shows a schematic diagram of an example generative adversarial model used to generate counterfactual synthetics). With reference to FIG. 3, as a generative adversarial model (GAN), StarGAN trains two models—a generator G and a discriminator D—and an additional domain classifier M. G inputs the target instance x that is of class y and the objective class γ to generate a similar instance x^{γ}. The training objectives are to make \tilde{x}^{γ}≈x and M(x^{γ})≈γ. The first objective further requires inputting \tilde{x}^{γ} and y into G to get \tilde{x}^{y} as output, then minimising cycle consistency reconstruction loss between x^{y} and x, which also improves x^{γ}. The second objective requires inputting x^{γ} into the domain classifier to output class \hat{γ}, then minimising the training loss between \hat{γ} and γ. Finally, D is trained to ensure that the generated instances are more realistic \tilde{d}. Together, these objectives provide a semi-supervised method to train the G to generate style-transferred instances.

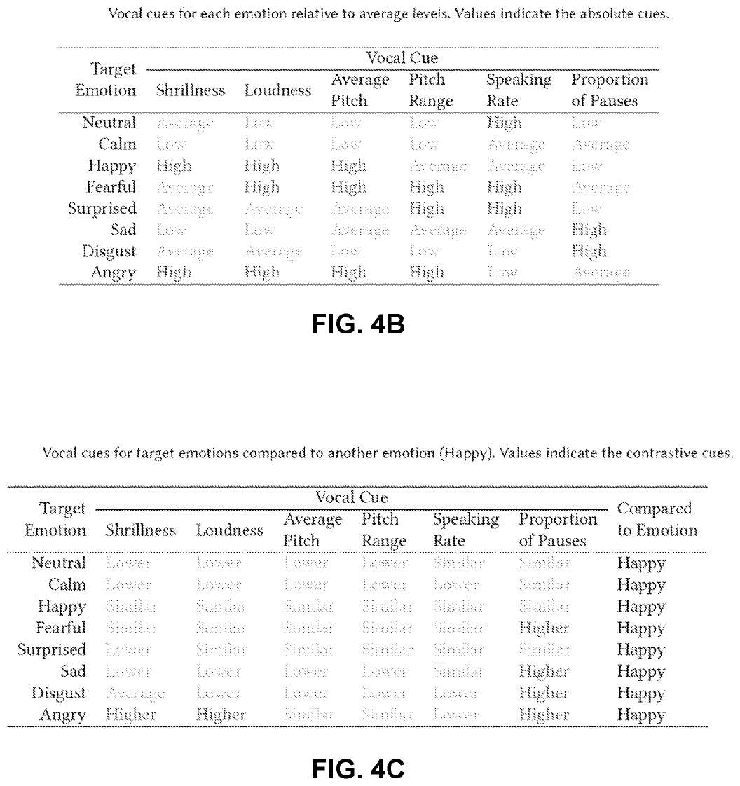

FIG. 4A illustrates the benefit of using counterfactual synthetics for comparison. FIG. 4A shows a conceptual illustration of the benefit of using counterfactual synthetics for comparison. Different example types (exemplar, counterfactual, prototype) have varying distances from the target instance. When deciding whether a target item is more similar to a first or second reference, one would measure the target's distance to each reference. Counterfactual synthesis produces comparison references that are closer to the target item being classified, because it minimizes the differences between the target item and reference example. These counterfactual references will be closer to other model exemplars that the model knows (prior instances in the training set), model prototypes (centroids or medoids of class clusters), or human mental exemplars (from the user's memory), since the model may not have a similar example, or the human may never have seen or heard a very similar case to the target item. This amplifies the ratio between the reference distances larger and makes the difference more perceptible. Formally, the ratio of differences for counterfactual synthetics are larger than for other examples (prototypes, or exemplars of prior items), i.e., |log(δ₁/δ₂)|>|log(d₁/d₂)|. Therefore, counterfactual synthetics help make comparison between references easier.

### RexNet: Contrastive Cues

The final contrastive explanation involves first inferring cues from the target and counterfactual instances and comparing them. The individual cues are defined as absolute cues (ĉ^{y} and ĉ^{γ}), and the difference as contrastive cues ĉ^{yγ}. 6 exemplary vocal cues for vocal emotions listed in FIG. 1B are used. Absolute cues can be inferred with machine learning predictions or heuristically. For vocal emotions, since the cues can be deterministically measured from the input data, heuristic methods [symbol] _{c} are used to infer the cues c. For example, pitch range is calculated as follows: a) calculate fundamental frequency (modal frequency bin) for each time window in the spectrogram, b) calculate their standard deviation for the full audio clip. For more semantically abstract cues, such as sounding “melodic”, “questioning tone”, or “nasally”, they should be annotated by humans and inferred using supervised learning.

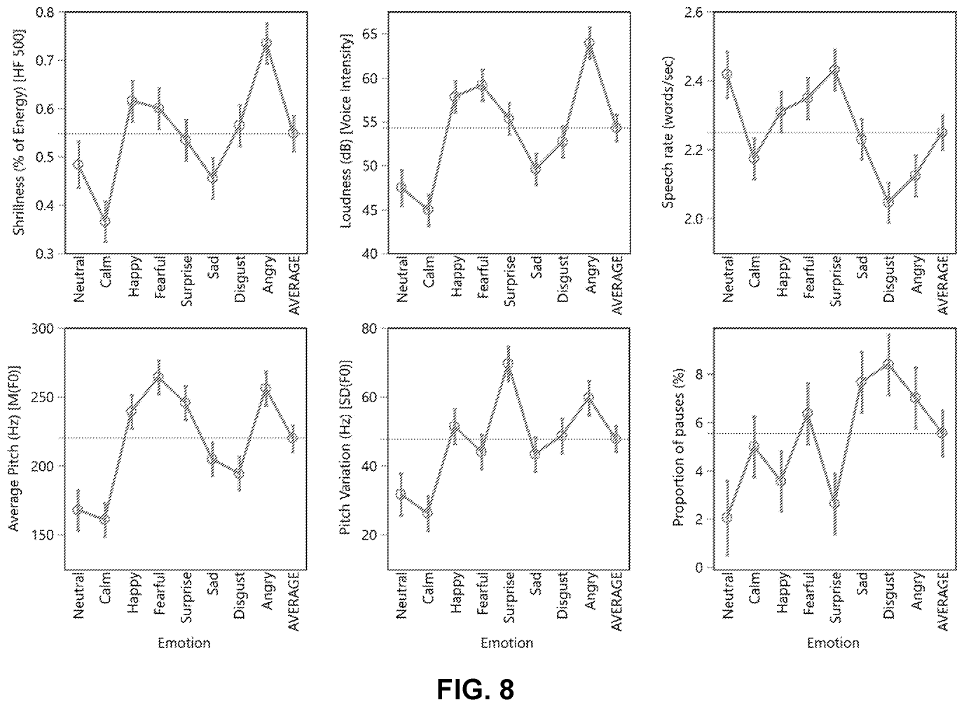

Contrastive cues are calculated as cue difference relations \hat{r}_{w}^{yγ} from numeric cue differences ĉ^{yγ} based on the instances in the RAVDESS dataset (Steven R Livingstone and Frank A Russo, 2018, The Ryerson Audio-Visual Database of Emotional Speech and Song (RAVDESS): A dynamic, multimodal set of facial and vocal expressions in North American English, PloS one 13, 5 (2018), e0196391). To determine differences between emotions for each cue, the data is fitted to a linear mixed effects model with emotion as the main fixed effect and voice actors as random effect (see FIG. 8) and a Tukey HSD test is performed with significance level α=0.005 to account for the multiple comparison effect. For each cue, if an emotion is not significantly higher than the other, then the cue difference is labelled as “similar”; otherwise, it is labelled as “higher” or “lower” depending on the direction. FIG. 4B describes the vocal cue patterns of each emotion compared to average levels. FIG. 4C describes the pairwise cue difference relations between each emotion and an emotion (happy).

Predicting the cue difference relations \hat{r}_{w}^{yγ} requires deciding the decision threshold at which to split the cue difference ĉ^{yγ} to categorize the relation, and this can contextually depend on initially estimating which emotion concepts ŷ₀ and \hat{γ}₀ to compare, and which cues are more relevant. This is defined as a multi-task model with two sub-models with fully connected neural network layers Mᵣ and M_{y}. M_{y}. takes in the numeric cue differences ĉ^{yγ} and embedding representations (from the penultimate fully connected layer) of the emotion concepts \hat{z}₀^{y} and \hat{z}₀^{γ} to predict the emotion ŷ heard in x. The relative importance of the cues are determined by calculating an attribution explanation ŵ_{c}^{yγ} with layer-wise relevance propagation (LRP) disclosed in, for example, Sebastian Bach et. al. 2015, on pixel-wise explanations for non-linear classifier decisions by layer-wise relevance propagation, PloS one 10, 7 (2015), e0130140. These attributions are then concatenated on ĉ^{yγ} to determine the weighted cue differences ŵ_{c}^{yγ}. Mᵣ takes in ŵ_{c}^{yγ}, \hat{z}₀^{y} and \hat{z}₀^{γ} to predict the cue difference relations \hat{r}_{w}^{yγ}. With the ground truth references, cue difference relations prediction can be trained using supervised learning. Since the cue difference relations (lower, similar, higher) are ordinal, the NNRank ordinal encoding disclosed in Jianlin Cheng et. al., 2008, A neural network approach to ordinal regression, In 2008 IEEE international joint conference on neural networks (IEEE world congress on computational intelligence) IEEE, 1279-1284, is used with 2 classes, such that lower=(0,0)^{T}, similar=(1,0)^{T}, higher=(1,1)^{T}, sigmoid activation, and binary cross-entropy loss for multi-label classification.

In other words, with reference to FIGS. 2A, 2B and 2C, embodiments of the present invention provide a method 300 for generating an explainable prediction of an emotion associated with a vocal sample x. The method 300 can be implemented with system 200 shown in FIG. 2B, which shows a schematic diagram of the system 200 for generating the explainable prediction of the emotion associated with the vocal sample. The system can include a processing device 202. The method 300 includes the step 302 of receiving, by the processing device 202, a vector representation \hat{z}₀^{y} of an initial prediction ŷ₀ of the emotion associated with the vocal sample, a counterfactual synthetic vocal sample \tilde{x}^{γ} associated with the vocal sample and an alternate emotion y different from the initial prediction of the emotion, a vector representation \hat{z}₀^{γ} of an emotion prediction \hat{γ}₀ associated with the counterfactual synthetic vocal sample, vocal cue information ĉ^{y}, ĉ^{γ} associated with the vocal sample and the counterfactual synthetic vocal sample and attribution explanation information ŵ_{c}^{yγ} associated with relative importance of the vocal cue information in prediction of the emotion. The method 300 also includes the step 304 of determining, using the processing device 202, numeric cue differences ĉ^{yγ} between the vocal cue information associated with the vocal sample and the vocal cue information associated with the counterfactual synthetic vocal sample, and the step 306 of generating, using the processing device 202, cue difference relations information \hat{r}_{w}^{yγ} based on the attribution explanation information (ŵ_{c}^{yγ}), the numeric cue differences, the vector representation of the initial prediction and the vector representation of the emotion prediction associated with the counterfactual synthetic vocal sample using a first neural network Mᵣ. The method 300 also includes step 308 of generating, using the processing device 202, a final prediction ŷ of the emotion based on the numeric cue differences, the vector representation of the initial prediction and the vector representation of the emotion prediction associated with the counterfactual synthetic vocal sample using a second neural network M_{y} and step 310 of generating, using the processing device 202, the explainable prediction of the emotion associated with the vocal sample based on at least the counterfactual synthetic vocal sample, the final prediction ŷ of the emotion and the cue difference relations information.

Embodiments of the present invention also provide a method 400 for training a neural network M_{y}. FIG. 2D shows the method 400 for training the neural network M_{y}. The method 400 includes a step 402 of receiving, by the processing device 202, a training vector representation of the emotion associated with the vocal sample, a training vector representation of an emotion prediction associated with a counterfactual synthetic vocal sample, the counterfactual synthetic vocal sample associated with the vocal sample and an alternate emotion different from the emotion, training numeric cue difference information associated with the vocal sample and the counterfactual synthetic vocal sample, and a reference emotion associated with the vocal sample. The method 400 also includes a step 404 of generating, using the processing device 202, an emotion prediction associated with the vocal sample based on the training numeric cue difference information, the training vector representation of the emotion associated with the vocal sample and the training vector representation of the emotion prediction associated with the counterfactual synthetic vocal sample using the neural network M_{y} and calculating, using the processing device 202, a classification loss value based on differences between the emotion prediction and the reference emotion. The method 400 also includes step updating, using the processing device 202, the neural network M_{y} to minimise the classification loss value.

Embodiments of the present invention also provide a method 500 for training a neural network Mᵣ. FIG. 2E shows the method 500 for training the neural network Mᵣ. The method 500 includes a step 502 of receiving, by the processing device 202, a training vector representation of the emotion associated with the vocal sample, a training vector representation of an emotion prediction associated with a counterfactual synthetic vocal sample, the counterfactual synthetic vocal sample associated with the vocal sample and an alternate emotion different from the emotion, training numeric cue difference information associated with the vocal sample and the counterfactual synthetic vocal sample, training attribution explanation information associated with relative importance of the vocal cue information in prediction of the emotion and reference cue difference relations information associated with the vocal sample and the counterfactual synthetic vocal sample. The method 500 also includes a step 504 of generating, using the processing device 202, cue difference relations information based on the training attribution information, the training numeric cue differences, the training vector representation of the initial prediction and the training vector representation of the emotion prediction associated with the counterfactual synthetic vocal sample using the neural network. The method 500 also includes a step 506 of calculating, using the processing device 202, a classification loss value based on differences between the cue difference relations information and the reference cue difference relations information and a step 508 of updating, using the processing device 202, the neural network to minimise the classification loss value.

A skilled person would appreciate that aforementioned training data in accordance with embodiments of the invention can include one or more of labelled and unlabelled training data samples. The skilled person would also appreciate that the aforementioned training data used to train neural networks M_{y} and Mᵣ can include information generated by a preceding module. For example, the training vector representations of the emotion associated with the vocal sample and the emotion prediction associated with the counterfactual synthetic vocal sample can be computed from domain classifiers M₀ and are unlabelled.

### RexNet Model Summary

RexNet consists of several modules to predict a concept and provide relatable explanations. Its primary task takes an input voice audio clip x to predict and output emotion concept y. For explanations, by specifying an additional input of a contrast emotion concept γ, the model generates explanations for the initial emotion concept ŷ₀, contrastive saliency \hat{ζ}^{yγ}, cue difference relations \hat{r}_{w}^{yγ}, and cue difference importance ŵ_{c}^{yγ}. Each of these explanations and other absolute explanations can be provided to the end-user. An exemplary explanation user interface is described in the next section.

### Relatable Explanation User Interface

FIG. 5A shows the exemplary user interface for showing all the relatable explanations together. After listening to the target voice clip (Input), the user can read the model's recognition of the emotion (Prediction), see the view a heatmap of important moments (Contrastive Saliency), listen to the voice as an alternative emotion (Counterfactual Synthetic/Sample), and compare the cues between the target and counterfactual voice clips (Contrastive Cues).

### Evaluations

The performance of the model is first evaluated, then two user studies are conducted to evaluate the usage and usefulness of the contrastive explanations. The user study was formative to qualitatively understand usage, and the second was summative to measure the effectiveness of each explanation type.

### Modeling Study—Method

Model prediction performance and explanation correctness are evaluated with several metrics (see FIG. 5B). The model performance of the initial and final predictions of emotion is measured and compared against that of the baseline CNN model. Performance was calculated with macro-average accuracy (of all classes). Each explanation type was evaluated with different metrics due to their different forms. Saliency maps are evaluated by the relevance of important features to the model prediction, and absolute and contrastive saliency are compared. The ablation approach of Kunpeng Li et. al., 2018, Tell me where to look: Guided attention inference network, in Proceedings of the IEEE Conference on Computer Vision and Pattern Recognition. 9215-9223, is used to identify more important features as those that cause larger decreases in model performance when that feature is ablated. The faithfulness counterfactual synthetics are evaluated with these metrics:
1) reconstruction similarity exp(-MSE(x,\tilde{x}^{γ})) between the input x and synthesized x^{γ}, calculated with mean square error MSE, to determine how similar they are;
2) the identity classification accuracy to indicate whether the counterfactual voice sounds like the same actor portraying the original emotion; and
3) the emotion classification accuracy with respect to the contrast emotion.

The correctness of cue difference relations \hat{r}_{w}^{yγ} is evaluated by comparing the inferred relations (i.e., higher, lower, similar) to the ground truth relations calculated from the dataset (e.g., see FIG. 4C, which shows a table listing vocal cues for target emotions compared to another emotion (happy). Values indicate the contrastive cues). The classification accuracy of the cues are reported below. All multi-class metrics are reported with their macro-averages.

### Modeling Study—Results

The dataset is split into 80% training and 20% test. FIG. 5B reports the test results. FIG. 5B shows a table listing evaluation results of model prediction performance and explanation correctness for RexNet and baseline models (Random, Base CNN). RexNet models compared include the full model, and one trained with Counterfactual Samples (C.Samples) without StarGAN used in user studies. Grey numbers calculated by definition, instead of from empirical results. * same as base CNN model. Training with the explainable modules helped RexNet to achieve higher emotion accuracy than the base CNN (79.5% vs. 75.7%). Though the final emotion accuracy is slightly lower than the initial emotion prediction (78.5% vs. 79.5%), this is expected since interpretability typically trades-off accuracy. The ablated accuracy decrease indicates that the saliency pixels are somewhat important. Contrastive Saliency has slightly less importance than Absolute Saliency (13.7% vs. 14.9%), because the former excludes pixels that are commonly important for all classes. Counterfactual synthesis was moderately successful achieving reasonable reconstruction similarity (reconstruction error MSE=0.680), good speaker re-identification (60.2% compared to 4.2% random chance), and somewhat recognizable emotion which is significantly better than random chance (30.7% vs. 12.5%). The predictions of cue difference relations were good (71.9%).

Although the counterfactual synthetic accuracy was better than chance, the accuracy is still too low to be used by people. Thus, evaluation is performed using Counterfactual Samples (C.Samples), which uses voice clips from the RAVDESS dataset corresponding to the same voice actor (identity), same speech words, but different portrayed contrast emotion. As expected, the identity and emotion accuracies are higher for Samples than Synthetics, but the other performances were comparable.

In the next step, the usage and usefulness of each explanation type is investigated. The focus is on the interactions and interface, rather than investigating whether each explanation as implemented is good enough. Therefore, instances with correct predictions and coherent explanations are selected for the user studies. Since the Counterfactual Synthesis performance is limited, Counterfactual Samples are used to represent counterfactual examples instead.

### Think-Aloud User Study

A formative study is conducted with the think-aloud protocol to understand 1) how people naturally infer emotions without system prediction or explanation, and 2) how users used or misunderstood various explanations.

### Think-Aloud User Study: Experiment Method and Procedure

14 participants are recruited from a university mailing list. The 14 participants include 3 males, 11 females, with ages between 21-40 years old. The study was conducted via an online Zoom audio call. The experiment took 40-50 minutes and each participant was compensated with a $10 SGD coffee gift card. The user task is a human-AI collaborative task for vocal emotion recognition. Given a voice clip, the participant has to infer the emotion portrayed with or without AI prediction and explanation. 16 voice clips of 2 neutral sentences were provided (neutral sentences: “dogs are sitting by the door” and “kids are talking by the door”). The neutral sentences are intoned to portray 8 emotions. Only correct system predictions and explanations were selected, since the study is not concerned with investigating the impact of erroneous predictions or misleading explanations. The study contains 4 explanation interface conditions: Contrastive Saliency only, Counterfactual Sample voice examples only, Counterfactual Sample and Contrastive Cues, and all 3 explanations together (see FIG. 5A).

The procedure is: read an introduction, consent to the study, complete a guided tutorial of all explanations (regardless of condition), and start the main study with multiple trials of a vocal emotion recognition task. To limit the participation duration, each participant completes three trials, each randomly assigned to an explanation interface condition. For each trial, the participant listened to a pre-recorded voice with a portrayed emotion and gave an initial label of the emotion. On the next page, the participant was shown the system's prediction with (or without) explanation based on the assigned condition. She could then revise her emotion label if she changed her mind. The think-aloud protocol is used to ask participants to articulate their thoughts as they examined the audio clip, prediction, and explanations. The participants were also asked for their perceptions using the interface, and any suggestions for improvement. The findings are described next.

### Think-Aloud User Study: Findings

The findings are described in terms of questions of how users innately infer vocal emotions, and how they used each explanation type. When inferring on their own, participants would focus on specific cues to “check the intonations [pitch variation] for decision” [Participant P12], infer a Sad emotion based on the “flatness of the voice” [P04], or “use shrillness to distinguish between fearful and surprise” [P01]. Participants also relied on changes in tone, which were not modeled. For example, a rising tone “sounds like the man is asking a question” [P02], “the last word has a questioning tone” [P03] helped participants to infer Surprise. The latter case identified the most relevant segment. In contrast, a “tone going down at the end of sentence” helped P01 infer Sad. Some participants also mentally generated their own examples to “imagine what neutral sound like and compare against it” [P05]. These unprompted behaviors suggest the relevance of providing saliency, counterfactual, and cue-based explanations.

The usage of explanations was mixed with some helpful and some issues. In general, participants could understand the saliency maps, e.g., P09 saw that “the highlight parts are consistent with my judgment for important words”, referring to ‘talking’ being highlighted. However, several participants had issues with saliency maps. There were some cases with highlights that spanned across multiple words and included highlighting spaces. P08 felt that saliency “should highlight all words”, and P14 “would prefer the color highlighted on text”. This lack of focus made P13 feel that “the color bar is not necessary”. Regularising the explanation to prioritize highlighting words and penalize highlighting spaces can help align the explanations with user expectations and improve trust. Next, P11 thought that “the color bar reflects the fluctuation of tone”. While plausible, this indicates the risk of misinterpreting technical visualizations for explanations. Finally, P12 “used the saliency bar by listening to the highlighted part of the words, and try to infer based on intonation. But I think the highlighting in this example is not accurate”. This demonstrates causal oversimplification by reasoning with one factor rather than multiple factors.

Many participants found counterfactual samples “intuitive”. P11 could “check whether it's consistent with my intuition” by mentally comparing the similarity of the target audio clip (sad) with clips for other suspected emotions (neutral, sad, happy). Unfortunately, her intuition was somewhat flawed, since she inferred Neutral which was wrong. Specifically, P12 found them “helpful to have a reference state, then I will also check the intonations for my decision.” Conversely, some participants felt counterfactual samples were not helpful. P06 felt that the “information [in the audio] was not helpful, since clips [neutral and calm] are too similar”. Had she received deeper explanations with saliency map or cue differences, she would have had more information about where and what the differences were, respectively.

Cues were used to check semantic consistency. P04 used cues to “confirm my judgment” and found that “[the] low shrillness [of Sad] is consistent with my understanding.” P06 reported that “cues mainly help me confirm my choice.” However, some participants perceived inconsistencies. P13 thought that “some cue descriptions were not consistent with my perception.” Specifically, he disagreed with the system that the Speaking Rate cue was similar for the Happy and Surprised audio clips. Along with the earlier case of P06, this suggests differences in perceptual acuity between the user and system to distinguish cue similarity. Strangely, P10 felt that “compared with [audio] clips, cue pattern is too abstract to use for comparison.” Perhaps, some cues were hard to relate to, such as Shrillness and Proportion of Pauses.

Finally, some participants felt that Counterfactual samples were more useful than Contrastive Cues. P11 found that “the comparison voice part is more helpful than the text part, though the text part is also helpful to reinforce my decision.” This could be due to cognitive load and differences between mental dual processing. Many participants considered the audio samples “quite intuitive” [P04]. They used System 1 thinking which is fast, though they did not articulate why this was simple. In contrast, they found that “it's hard to describe or understand the voice cue patterns” [P04]. This requires slower System 2 thinking. Another possible reason is that the audio clip has higher information bandwidth than the 6 verbally presented semantic cues. Participants can perceive the gestalt of the audio to make their inferences.

### Controlled User Study

Having identified various benefits and usages of contrastive explanation, a summative controlled study is conducted to understand 1) how well participants could infer vocal emotions on their own, and with system (model) predictions and explanations, and 2) how various explanations affect their perceived system trust and helpfulness.

### Controlled User Study—Experiment Design and Apparatus

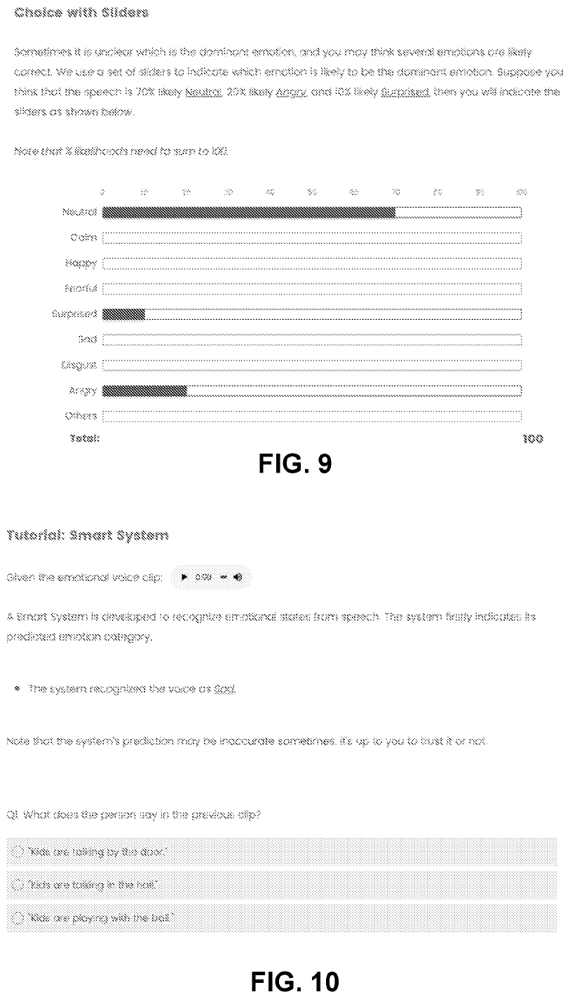

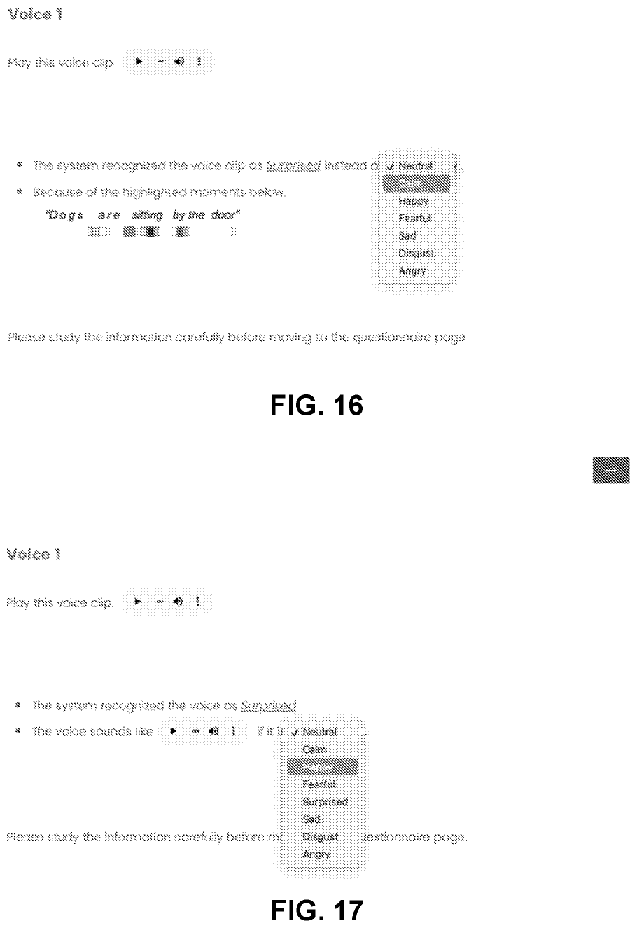

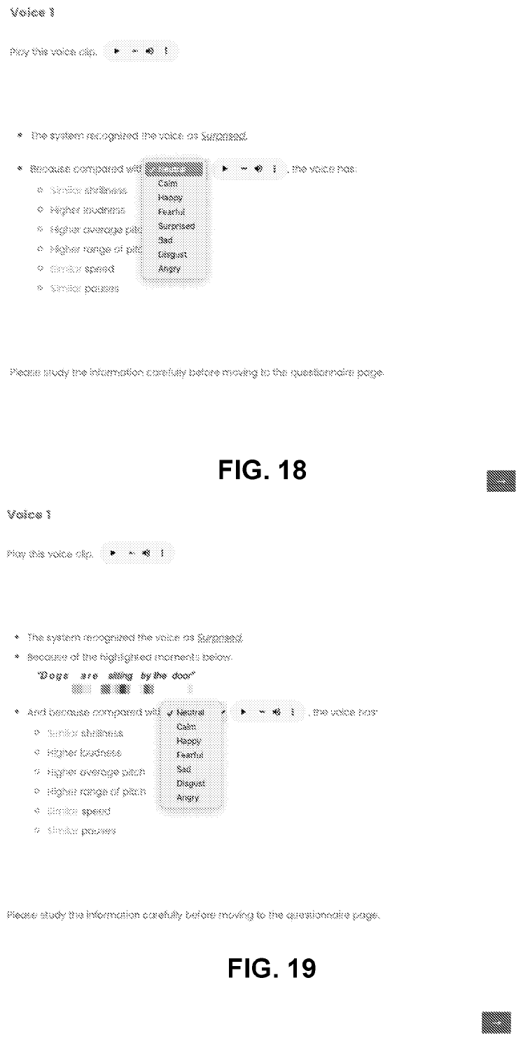

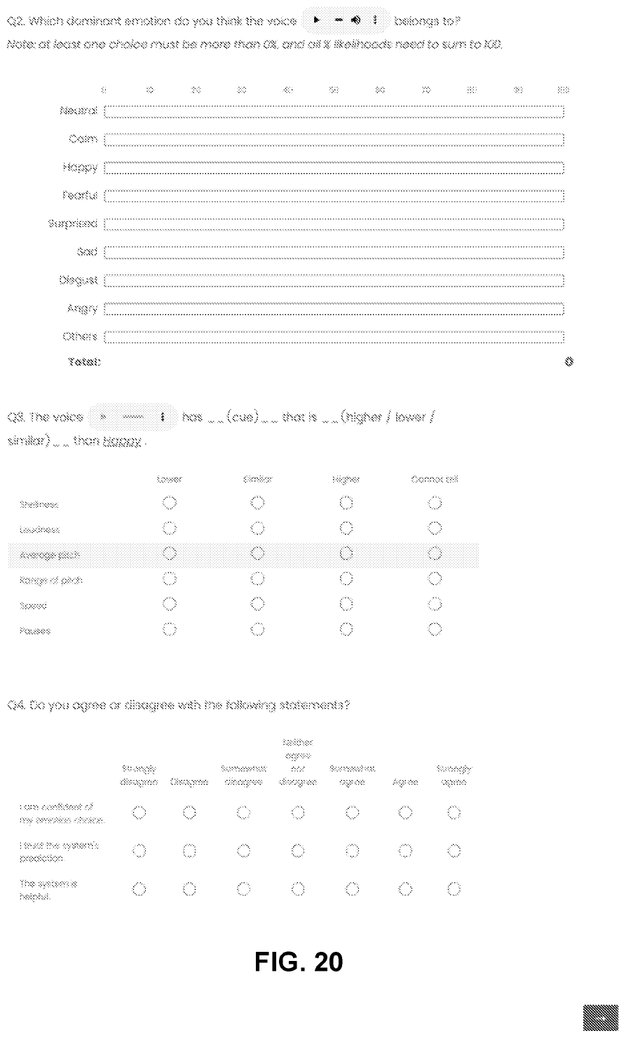

A mixed-design experiment is conducted with XAI Type as the independent variable with 5 levels indicating different combinations of explanations (Prediction only, Contrastive Saliency, Counterfactual Sample, Counterfactual+Contrastive Cues, and Saliency+Counterfactual+Cues (AII)). The user task is to label the portrayed emotion in a voice clip with feedback from the AI in one of the XAI Types. Portrayed emotion is included as a random variable with 8 levels (Neutral, Calm, Happy, Fearful, Surprise, Sad, Disgust, and Angry). Having many emotions helps to make the task more challenging to test. FIG. 5A shows the UI with all explanations together, and others are shown in FIGS. 15-19. For dependent variables, decision quality (emotion label correctness), understanding of cue differences, task times, perceptions on decision confidence, perceived trust of the system, and perceived helpfulness are measured. Labelling correctness was measured with a “balls and bins” question that elicits the probability of multiple labels (see FIG. 9) [Daniel G Goldstein and David Rothschild, 2014, Lay understanding of probability distributions, Judgment & Decision Making 9, 1 (2014)]. Cue difference understanding was measured per cue with a multiple-choice question for the cue difference relation between a randomly selected contrast emotion label and the target voice clip. Task times were logged for different pages. Perceptions were measured as ratings on a 7-point Likert scale (−3=Strongly Disagree, +3=Strongly Agree). FIG. 20 shows these measures as survey questions.

### Controlled User Study—Experiment Procedure

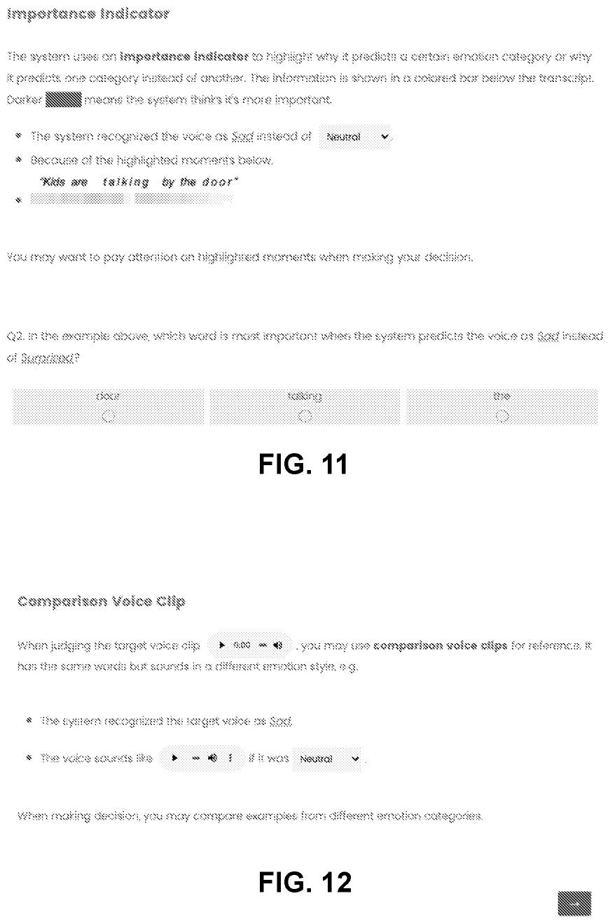

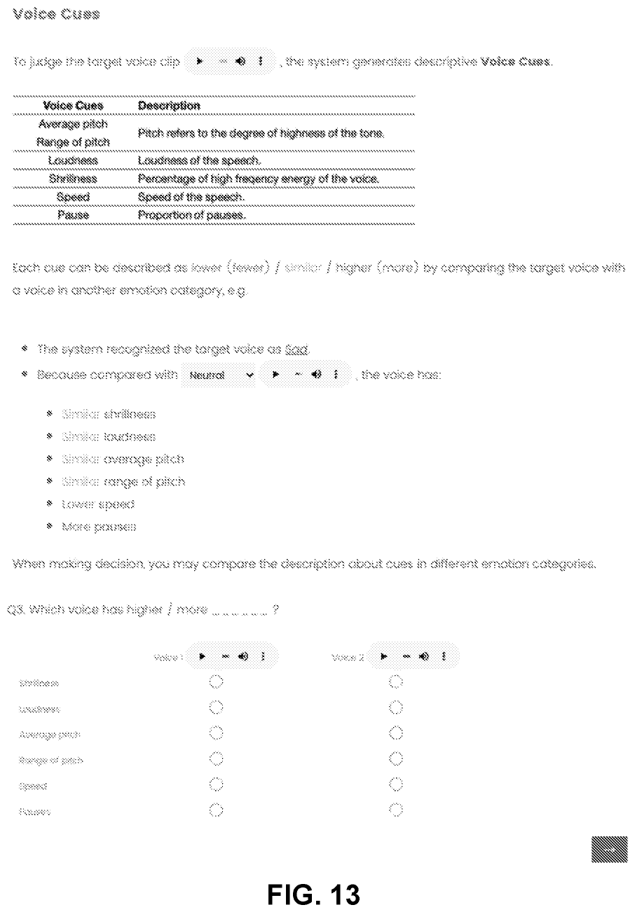

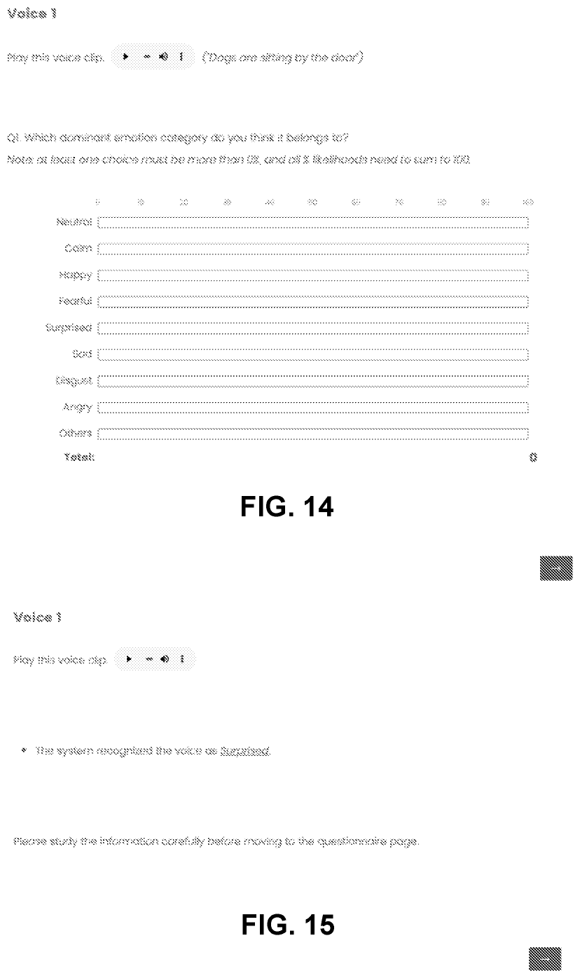

The participant reads an introduction, consents to the study, reads a short tutorial about the explanation interfaces, and completes a screening test where she is asked to a) listen to a voice clip and select from multiple choices regarding the correct words in the speech (see FIG. 10), b) demonstrate that she can read a saliency map to identify important words (see FIG. 11) and c) demonstrate that she can perceive easy cue differences between two voice clips (see FIG. 13). The screening tests the participant's audio equipment and auditory acuity. After passing screening (with all questions correct), the participant completes the main study in two sessions with a break in-between.

The participant is randomly assigned to an XAI type in each session. Each session comprises 8 trials with three pages: i) pre-AI to label the emotion without AI assistance, ii) XAI to read any prediction and explanation feedback, and iii) post-XAI to answer questions about emotion labeling (again), cue difference understanding, and perceived rating. The participant is incentivized to be fast and correct with a maximum $0.50 USD bonus for completing all trials within 8 minutes. The bonus is pro-rated by the number of correct emotion labels. Maximum bonus is $1.00 for two sessions over a base compensation of $2.50 USD. The participant ends with answering demographic questions.

### Controlled User Study—Statistical Analysis and Quantitative Results

162 participants were recruited from Amazon Mechanical Turk (AMT) with high qualifications (≥5000 completed HITs with >97% approval rate). They were 58.9% male, with ages 22-72 (Median=37). Participants took 30.9 minutes (median) to complete the survey on average.

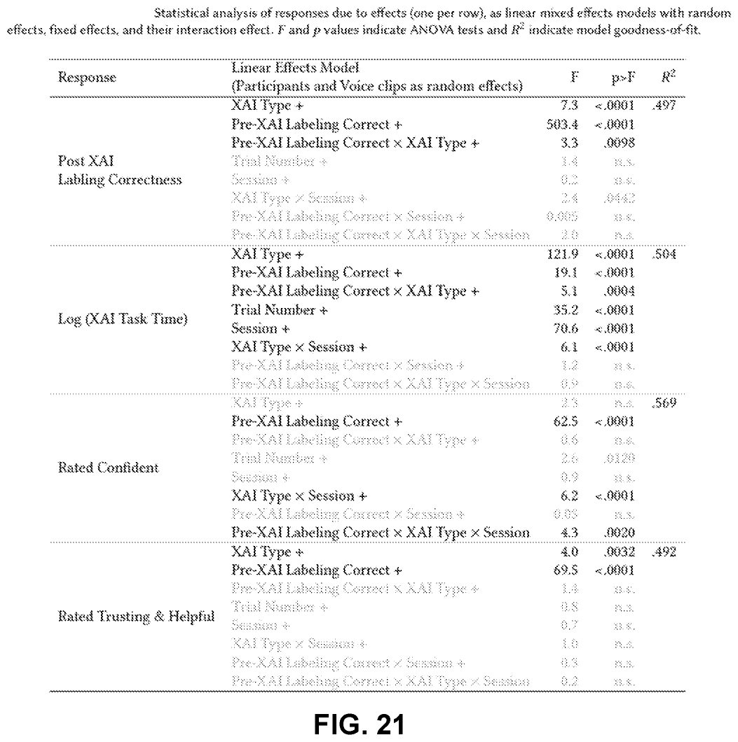

For analysis, ratings for Trust and Helpfulness were combined since they were highly correlated. The Likert ratings were binarised to agree (>0) and disagree. For each response (dependent) variable, a linear mixed-effects model is fitted with XAI Type, Emotion, Session, and Pre-XAI Labeling Correctness as main fixed effects, several main interaction effects, and Participant and Voice Clip as random effects (see FIG. 21 for details). Results are reported at a stricter significance level (p<0.0001) to account for multiple comparisons. There was a notable difference between the first and second session due to learning effects of participants learning how to infer emotions due to being exposed to the prior explanation interface.

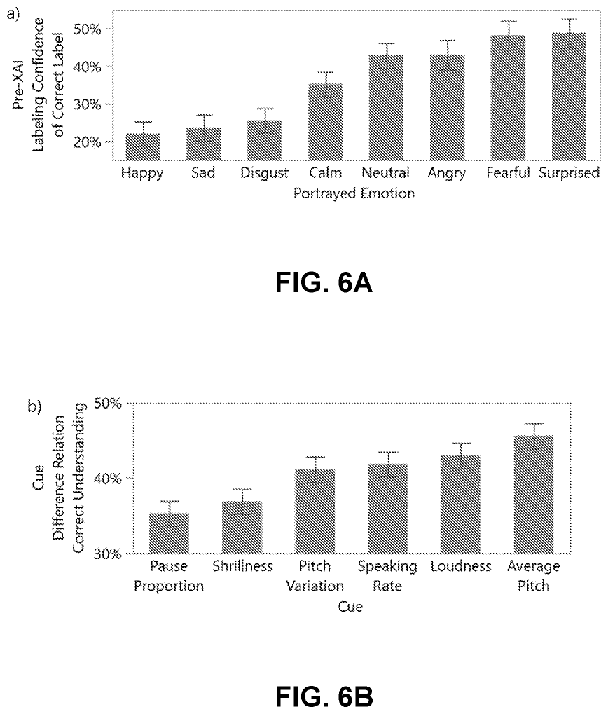

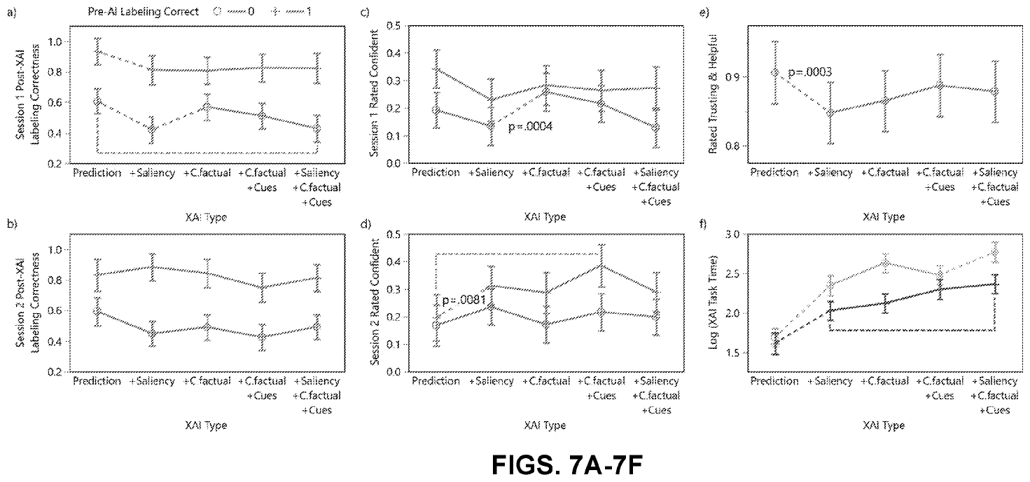

XAI Type had a limited effect on decision quality. All participants had middling performance when initially inferring emotions (M=40.8% for pre-XAI) and describing cue difference relations (M=40.6%); there was no difference across XAI Types, but there were differences across emotion type and cues (see FIGS. 6A and 6B). Decision quality are analyzed after viewing XAI, and the analysis is split between whether participants answered correctly pre-XAI (see FIGS. 7A and 7B). Interestingly, participants who viewed Prediction only had higher post-XAI correctness than those who viewed explanations. This could be due to them blindly trusting the AI and copying its prediction, instead of second-guessing their decisions after examining explanations. The lowered decision quality was most pronounced with Saliency explanations. This could be due to them being quite technical and error prone (some highlights are imprecise as described in the think-aloud study). Nevertheless, for participants who were initially wrong, Counterfactual Samples helped to mitigate their decision errors. There was no difference across XAI Types in the second session.

Explanations left some impression on participant perceptions. Notably, in Session 2, participants who were initially correct had higher confidence after viewing explanations, especially Counterfactual Samples with Contrastive Cues (see FIG. 7D). This effect was not prevalent in Session 1, perhaps, because participants were yet unaware of better AI interfaces, leading to higher individual variance. Perceived Trust and Helpfulness followed a similar pattern as decision quality (see FIG. 7E). As expected, richer, more relatable explanations needed more time for participants to examine (see FIG. 7F).

### Controlled User Study—Summary of Results

The results from the three aforementioned evaluation studies are summarised. The modelling study showed that RexNet provides reasonable Saliency explanations, accurate Contrastive Cues explanations, and had better Counterfactual Synthetics than random chance (though this should be improved for deployment). Surprisingly, these explanations helped to improve the RexNet's performance over the base CNN. The think-aloud user study showed how RexNet explanation capabilities align with how users innately perceive and infer vocal emotions, hence verifying the XAI Perceptual Processing framework. Limitations in user perception and reasoning that led to some interpretation issues were also identified.

The controlled user study showed that relatable explanations can improve user confidence for participants who tended to agree with the AI, and only after sufficient exposure (Session 2). Though the explanations did not improve their understanding or decision quality. The results present a cautionary tale that some explanations may be detrimental to user task performance. This is especially so for Saliency explanations that are rather technical or error prone and may be inconsistent with counterfactual and cue explanations. These issues may have confused participants. It is noted that the results do not align with Wang et al., Are Explanations Helpful? A Comparative Study of the Effects of Explanations in AI-Assisted Decision-Making, In 26th International Conference on Intelligent User Interfaces. 318-328, that found the opposite effect that attribution explanations were more useful than counterfactuals; this could be due to the difference of interpreting structured or unstructured data. Reasons that may be considered for the lack of significant results include: 1) emotion prosody is an innate skill, so many users may not need or want to rely on explanations in their decisions; 2) the model and explanations need to be further improved to provide compelling and insightful feedback; and 3) stronger effects may be detectable with a longitudinal experiment.

### Discussion

In summary, a framework and architecture for relatable explainable AI was proposed and evaluated. Improvements to the approach and implications for human-centric XAI research are discussed.

### Discussion—Extension of Explainable Vocal Emotion Prediction

While the present disclosure focused on recognising emotions by their verbal expressions, it can be appreciated that other vocal stimulus types and prosodic attributes such as non-verbal expressions, affect bursts, and lexical information can be leveraged on. For example, change in tone in voices can be used to infer emotion and this can be included as a vocal cue.

It can also be appreciated that counterfactual synthesis can be improved by using newer generators, such as Sequence-to-Sequence Voice Conversion [Hirokazu Kameoka et. al., 2020, ConvS2S-VC: Fully convolutional sequence-to-sequence voice conversion, IEEE/ACM Transactions on Audio, Speech, and Language Processing 28 (2020), 1849-1863], and StarGAN-VC v2 [Takuhiro Kaneko et. al., StarGAN-VC2: Rethinking conditional methods for StarGAN-based voice conversion. arXiv preprint arXiv:1907.12279 (2019)]. It can also be appreciated that explanation annotation and debiased training the explanations towards user expectations can help to align explanations with user expectation and improve the coherence between the different explanation types. While contrastive cue relations were encoded as a table, they could be represented as another data structure (e.g., decision trees or causal graphs) to better fit human mental models. Further testing can evaluate the usage and usefulness of predictions and explanations in in-the-wild applications such as with smart speakers (e.g., Amazon Echo), smartphone digital assistants for mental health or emotion monitoring, or call-center employee AI coaching.

### CONCLUSION

The need to increase trust in AI has driven the development of many explainable AI (XAI) techniques and algorithms. However, many of them remain too technical, or focus on supporting data scientists and machine learning model developers. There is a need to support different stakeholders and less technical users and towards this end, the present disclosure provides how human cognition can determine the requirements for XAI. The present disclosure identifies the requirements for explanations to be relatable and contextualized to be more meaningfully interpreted. Specifically, four criteria for relatability are identified: contrastive concepts, saliency, counterfactuals, and associated cues. It can be appreciated that explanations can be made more relatable by providing for other criteria such as: social proof, narrative stories or rationalizations, analogies, user-defined concepts, and plausible explanations aligned with prior expectations. Human cognition has natural flaws, like cognitive biases and limited working memory. XAI can include designs and capabilities to mitigate cognitive biases, moderate cognitive load, and accommodate information handling preferences.

Embodiments of the present invention and the XAI perceptual processing framework disclosed herein unifies a set of contrastive, saliency, counterfactual and cues explanations towards relatable explainable AI. The framework was implemented with RexNet, a modular multi-task deep neural network with multiple explanations, trained to predict vocal emotions. From qualitative think-aloud and quantitative controlled studies, varying usage and usefulness across the contrastive explanations are found. Embodiments of the present invention can give insights into providing and evaluating relatable contrastive explainable AI for perception applications and contribute a new basis towards human-centered XAI.

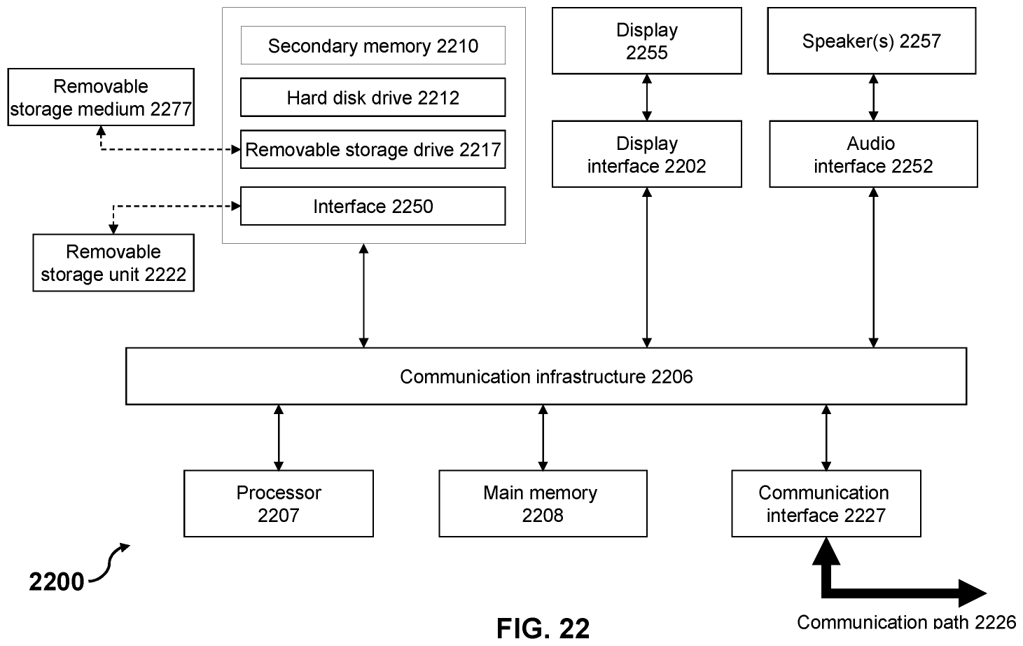

FIG. 22 depicts an exemplary computing device 2200, hereinafter interchangeably referred to as a computer system 2200, where one or more such computing devices 2200 may be used to execute the methods 300, 400 and 500 of FIGS. 2C, 2D and 2E. One or more components of the exemplary computing device 2200 can also be used to implement the system 320. The following description of the computing device 2200 is provided by way of example only and is not intended to be limiting.

As shown in FIG. 22, the example computing device 2200 includes a processor 2207 for executing software routines. Although a single processor is shown for the sake of clarity, the computing device 2200 may also include a multi-processor system. The processor 2207 is connected to a communication infrastructure 2206 for communication with other components of the computing device 2200. The communication infrastructure 2206 may include, for example, a communications bus, cross-bar, or network.

The computing device 2200 further includes a main memory 2208, such as a random access memory (RAM), and a secondary memory 2210. The secondary memory 2210 may include, for example, a storage drive 2212, which may be a hard disk drive, a solid state drive or a hybrid drive and/or a removable storage drive 2217, which may include a magnetic tape drive, an optical disk drive, a solid state storage drive (such as a USB flash drive, a flash memory device, a solid state drive or a memory card), or the like. The removable storage drive 2217 reads from and/or writes to a removable storage medium 2277 in a well-known manner. The removable storage medium 2277 may include magnetic tape, optical disk, non-volatile memory storage medium, or the like, which is read by and written to by removable storage drive 2217. As will be appreciated by persons skilled in the relevant art(s), the removable storage medium 2277 includes a computer readable storage medium having stored therein computer executable program code instructions and/or data.

In an alternative implementation, the secondary memory 2210 may additionally or alternatively include other similar means for allowing computer programs or other instructions to be loaded into the computing device 2200. Such means can include, for example, a removable storage unit 2222 and an interface 2250. Examples of a removable storage unit 2222 and interface 2250 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 2222 and interfaces 2250 which allow software and data to be transferred from the removable storage unit 2222 to the computer system 2200.

The computing device 2200 also includes at least one communication interface 2227. The communication interface 2227 allows software and data to be transferred between computing device 2200 and external devices via a communication path 2226. In various embodiments of the inventions, the communication interface 2227 permits data to be transferred between the computing device 2200 and a data communication network, such as a public data or private data communication network. The communication interface 2227 may be used to exchange data between different computing devices 2200 which such computing devices 2200 form part an interconnected computer network. Examples of a communication interface 2227 can include a modem, a network interface (such as an Ethernet card), a communication port (such as a serial, parallel, printer, GPIB, IEEE 1394, RJ45, USB), an antenna with associated circuitry and the like. The communication interface 2227 may be wired or may be wireless. Software and data transferred via the communication interface 2227 are in the form of signals which can be electronic, electromagnetic, optical or other signals capable of being received by communication interface 2227. These signals are provided to the communication interface via the communication path 2226.

As shown in FIG. 22, the computing device 2200 further includes a display interface 2202 which performs operations for rendering images to an associated display 2250 and an audio interface 2252 for performing operations for playing audio content via associated speaker(s) 2257.

As used herein, the term “computer program product” may refer, in part, to removable storage medium 2277, removable storage unit 2222, a hard disk installed in storage drive 2212, or a carrier wave carrying software over communication path 2226 (wireless link or cable) to communication interface 2227. Computer readable storage media refers to any non-transitory, non-volatile tangible storage medium that provides recorded instructions and/or data to the computing device 2200 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 2200. Examples of transitory or non-tangible computer readable transmission media that may also participate in the provision of software, application programs, instructions and/or data to the computing device 2200 include radio or infra-red transmission channels as well as a network connection to another computer or networked device, and the Internet or Intranets including e-mail transmissions and information recorded on Websites and the like.

The computer programs (also called computer program code) are stored in main memory 2208 and/or secondary memory 2210. Computer programs can also be received via the communication interface 2227. Such computer programs, when executed, enable the computing device 2200 to perform one or more features of embodiments discussed herein. In various embodiments, the computer programs, when executed, enable the processor 2207 to perform features of the above-described embodiments. Accordingly, such computer programs represent controllers of the computer system 2200.

Software may be stored in a computer program product and loaded into the computing device 2200 using the removable storage drive 2217, the storage drive 2212, or the interface 2250. The computer program product may be a non-transitory computer readable medium. Alternatively, the computer program product may be downloaded to the computer system 2200 over the communication path 2226. The software, when executed by the processor 2207, causes the computing device 2200 to perform the necessary operations to execute the method 100 as shown in FIG. 1.

It is to be understood that the embodiment of FIG. 22 is presented merely by way of example to explain the operation and structure of the system 2200. Therefore, in some embodiments one or more features of the computing device 2200 may be omitted. Also, in some embodiments, one or more features of the computing device 2200 may be combined together. Additionally, in some embodiments, one or more features of the computing device 2200 may be split into one or more component parts.

It will be appreciated that the elements illustrated in FIG. 22 function to provide means for performing the various functions and operations of the system as described in the above embodiments.

When the computing device 2200 is configured to realise the system 200 to generating an explainable prediction of an emotion associated with a vocal sample, the system 200 will have a non-transitory computer readable medium having stored thereon an application which when executed causes the system 200 to perform steps comprising: receiving a vector representation (\hat{z}₀^{y}) of an initial prediction (ŷ₀) of the emotion associated with the vocal sample (x), a counterfactual synthetic vocal sample (\tilde{x}^{γ}) associated with the vocal sample (x) and an alternate emotion (γ) different from the initial prediction (ŷ₀) of the emotion, a vector representation (\hat{z}₀^{γ}) of an emotion prediction (\hat{γ}₀) associated with the counterfactual synthetic vocal sample (\tilde{x}^{γ}), vocal cue information (ĉ^{y}, ĉ^{γ}) associated with the vocal sample (x) and the counterfactual synthetic vocal sample (\tilde{x}^{γ}) and attribution explanation information (ŵ_{c}^{yγ}) associated with relative importance of the vocal cue information (ĉ^{y}, ĉ^{γ}) in prediction of the emotion. The method also includes determining numeric cue differences (ĉ^{yγ}) between the vocal cue information (ĉ^{y}) associated with the vocal sample (x) and the vocal cue information (ĉ^{γ}) associated with the counterfactual synthetic vocal sample (\tilde{x}^{γ}), generating cue difference relations information (\hat{r}_{w}^{yγ}) based on the attribution explanation information (ĉ_{c}^{yγ}), the numeric cue differences (ĉ^{yγ}), the vector representation (\hat{z}₀^{y}) of the initial prediction (ŷ₀) and the vector representation (\hat{z}₀^{γ}) of the emotion prediction (\hat{γ}₀) associated with the counterfactual synthetic vocal sample (\tilde{x}^{γ}) using a first neural network (Mᵣ), generating a final prediction (ŷ) of the emotion based on the numeric cue differences (ĉ^{yγ}), the vector representation (\hat{z}₀^{y}) of the initial prediction (ŷ₀) and the vector representation (\hat{z}₀^{γ}) of the emotion prediction (\hat{γ}₀) associated with the counterfactual synthetic vocal sample (\tilde{x}^{γ}) using a second neural network (M_{y}), and generating the explainable prediction of the emotion associated with the vocal sample (x) based on at least the counterfactual synthetic vocal sample (\tilde{x}^{γ}), the final prediction (ŷ) of the emotion and the cue difference relations information (\hat{r}_{w}^{yγ}).

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for generating an explainable prediction of an emotion associated with a vocal sample (x), the method comprising:
receiving, by a processing device:
a vector representation (\hat{z}₀^{y}) of an initial prediction (ŷ₀) of the emotion associated with the vocal sample (x);
a counterfactual synthetic vocal sample (\tilde{x}^{γ}) associated with the vocal sample (x) and an alternate emotion (γ) different from the initial prediction (ŷ₀) of the emotion;
a vector representation (\hat{z}₀^{γ}) of an emotion prediction (\hat{γ}₀) associated with the counterfactual synthetic vocal sample (\tilde{x}^{γ});
vocal cue information (ĉ^{y}, ĉ^{γ}) associated with the vocal sample (x) and the counterfactual synthetic vocal sample (\tilde{x}^{γ}); and
attribution explanation information (ŵ_{c}^{yγ}) associated with relative importance of the vocal cue information (ĉ^{y}, ĉ^{γ}) in prediction of the emotion;
determining, using the processing device, numeric cue differences (ĉ^{yγ}) between the vocal cue information (ĉ^{y}) associated with the vocal sample (x) and the vocal cue information (ĉ^{γ}) associated with the counterfactual synthetic vocal sample (\tilde{x}^{γ});
generating, using the processing device, cue difference relations information (\hat{r}_{w}^{yγ}) based on the attribution explanation information (ŵ_{c}^{yγ}), the numeric cue differences (ĉ^{yγ}), the vector representation (\hat{z}₀^{y}) of the initial prediction (ŷ₀) and the vector representation (\hat{z}₀^{γ}) of the emotion prediction (\hat{γ}₀) associated with the counterfactual synthetic vocal sample (\tilde{x}^{γ}) using a first neural network (Mᵣ);
generating, using the processing device, a final prediction (ÿ) of the emotion based on the numeric cue differences (ĉ^{yγ}), the vector representation (\hat{z}₀^{y}) of the initial prediction (ŷ₀) and the vector representation (\hat{z}₀^{γ}) of the emotion prediction (\hat{γ}₀) associated with the counterfactual synthetic vocal sample (\tilde{x}^{γ}) using a second neural network (M_{y}); and
generating, using the processing device, the explainable prediction of the emotion associated with the vocal sample (x) based on at least the counterfactual synthetic vocal sample (\tilde{x}^{γ}), the final prediction (ŷ) of the emotion and the cue difference relations information (\hat{r}_{w}^{yγ}).

2. The method as claimed in claim 1, wherein the step of receiving the counterfactual synthetic vocal sample (\tilde{x}^{γ}) comprises generating, using the processing device, the counterfactual synthetic vocal sample (\tilde{x}^{γ}) based on the vocal sample (x) and the alternate emotion (γ) using a generative adversarial network (G_{*GAN}).

3. The method as claimed in claim 1, wherein the step of receiving the vocal cue information (ĉ^{y}, ĉ^{γ}) associated with the vocal sample (x) and the counterfactual synthetic vocal sample (\tilde{x}^{γ}) comprises:
generating, using the processing device, a contrastive saliency explanation \hat{ζ}^{yγ}) based on the vocal sample (x), the initial prediction (ŷ₀), and the alternate emotion (γ) using a visual explanation algorithm; and
determining, using the processing device, the vocal cue information (ĉ^{y}) associated with the vocal sample (x) based on the vocal sample (x) and the contrastive saliency explanation (\hat{ζ}^{yγ}), and the vocal cue information (ê^{γ}) associated with counterfactual synthetic vocal sample (\tilde{x}^{γ}) based on the counterfactual synthetic vocal sample (\tilde{x}^{γ}) and the contrastive saliency explanation (\hat{ζ}^{yγ}).

4. The method as claimed in claim 1, wherein the vocal cue information (ĉ^{y}, ĉ^{γ}) is associated with one or more of a group consisting of: shrillness, loudness, average pitch, pitch range, speaking rate and proportion of pauses.

5. A system for generating an explainable prediction of an emotion associated with a vocal sample (x), the system comprising a processing device configured to:
receive:
a vector representation (\hat{z}₀^{y}) of an initial prediction (ŷ₀) of the emotion associated with the vocal sample (x);
a counterfactual synthetic vocal sample (\tilde{x}^{γ}) associated with the vocal sample (x) and an alternate emotion (γ) different from the initial prediction (ŷ₀) of the emotion;
a vector representation (\hat{z}₀^{γ}) of an emotion prediction (\hat{γ}₀) associated with the counterfactual synthetic vocal sample (\tilde{x}^{γ});
vocal cue information (ĉ^{y}, ĉ^{γ}) associated with the vocal sample (x) and the counterfactual synthetic vocal sample (\tilde{x}^{γ}); and
attribution explanation information (ŵ_{c}^{yγ}) associated with relative importance of the vocal cue information (ĉ^{y}, ĉ^{γ}) in prediction of the emotion;
determine numeric cue differences (ĉ^{yγ}) between the vocal cue information (ĉ^{y}) associated with the vocal sample (x) and the vocal cue information (ĉ^{γ}) associated with the counterfactual synthetic vocal sample (\tilde{x}^{γ});
generate cue difference relations information (\hat{r}_{w}^{yγ}) based on the attribution explanation information (ŵ_{c}^{yγ}), the numeric cue differences (ĉ^{yγ}), the vector representation (\hat{z}₀^{y}) of the initial prediction (ŷ₀) and the vector representation (\hat{z}₀^{γ}) of the emotion prediction (\hat{γ}₀) associated with the counterfactual synthetic vocal sample (\tilde{x}^{γ}) using a first neural network (Mᵣ);
generate a final prediction (ŷ) of the emotion based on the numeric cue differences (ĉ^{yγ}), the vector representation (\hat{z}₀^{y}) of the initial prediction (ŷ₀) and the vector representation (\hat{z}₀^{γ}) of the emotion prediction (\hat{γ}₀) associated with the counterfactual synthetic vocal sample (\tilde{x}^{γ}) using a second neural network (M_{y}); and
generate the explainable prediction of the emotion associated with the vocal sample (x) based on at least the counterfactual synthetic vocal sample (\tilde{x}^{γ}), the final prediction (ŷ) of the emotion and the cue difference relations information (\hat{r}_{w}^{yγ}).

6. The system as claimed in claim 5, wherein the processing device is configured to generate the counterfactual synthetic vocal sample (\tilde{x}^{γ}) based on the vocal sample (x) and the alternate emotion (γ) using a generative adversarial network (G_{*GAN}).

7. The system as claimed in claim 5, wherein the processing device is configured to:
generate a contrastive saliency explanation (\hat{ζ}^{yγ}) based on the vocal sample (x), the initial prediction (ŷ₀), and the alternate emotion (γ) using a visual explanation algorithm; and
determine the vocal cue information (ĉ^{y}) associated with the vocal sample (x) based on the vocal sample (x) and the contrastive saliency explanation (\hat{ζ}^{yγ}), and the vocal cue information (ĉ^{y}) associated with counterfactual synthetic vocal sample (\tilde{x}^{γ}) based on the counterfactual synthetic vocal sample (\tilde{x}^{γ}) and the contrastive saliency explanation (\hat{ζ}^{yγ}).

8. The system as claimed in claim 5, wherein the vocal cue information (ĉ^{y}, ĉ^{γ}) is associated with one or more of a group consisting of: shrillness, loudness, average pitch, pitch range, speaking rate and proportion of pauses.

9. A method for training a neural network (M_{y}), the method comprising:
receiving, by a processing device:
a training vector representation of the emotion associated with the vocal sample (x);
a training vector representation of an emotion prediction associated with a counterfactual synthetic vocal sample (\tilde{x}^{γ}), the counterfactual synthetic vocal sample (\tilde{x}^{γ}) associated with the vocal sample (x) and an alternate emotion (γ) different from the emotion;
training numeric cue difference information associated with the vocal sample (x) and the counterfactual synthetic vocal sample (\tilde{x}^{γ}); and
a reference emotion (y) associated with the vocal sample (x);
generating, using the processing device, an emotion prediction associated with the vocal sample (x) based on the training numeric cue difference information, the training vector representation of the emotion associated with the vocal sample (x) and the training vector representation of the emotion prediction associated with the counterfactual synthetic vocal sample (\tilde{x}^{γ}) using the neural network (M_{y});
calculating, using the processing device, a classification loss value based on differences between the emotion prediction and the reference emotion (y); and updating, using the processing device, the neural network (M_{y}) to minimise the classification loss value.

10. The method as claimed in claim 9, further comprising calculating, using the processing device, attribution explanation information (ŵ_{c}^{yγ}) with layer-wise relevance propagation of the neural network (M_{y}), the attribution explanation information (ŵc^{yγ}) associated with relative importance of the vocal cue information in prediction of the emotion.

11. A method for training a neural network (Mᵣ), the method comprising:
receiving, by a processing device:
a training vector representation of the emotion associated with the vocal sample (x);
a training vector representation of an emotion prediction associated with a counterfactual synthetic vocal sample (\tilde{x}^{γ}), the counterfactual synthetic vocal sample (\tilde{x}^{γ}) associated with the vocal sample (x) and an alternate emotion (γ) different from the emotion;
training numeric cue difference information associated with the vocal sample (x) and the counterfactual synthetic vocal sample (\tilde{x}^{γ});
training attribution explanation information associated with relative importance of the vocal cue information in prediction of the emotion; and
reference cue difference relations information (r_{w}^{yγ}) associated with the vocal sample (x) and the counterfactual synthetic vocal sample (\tilde{x}^{γ});
generating, using the processing device, cue difference relations information based on the training attribution information, the training numeric cue differences, the training vector representation of the initial prediction and the training vector representation of the emotion prediction associated with the counterfactual synthetic vocal sample (\tilde{x}^{γ}) using the neural network (Mᵣ);
calculating, using the processing device, a classification loss value based on differences between the cue difference relations information and the reference cue difference relations information (r_{w}^{yγ}); and
updating, using the processing device, the neural network (Mᵣ) to minimise the classification loss value.

12. The method as claimed in claim 9, wherein the vocal cue information is associated with one or more of a group consisting of: shrillness, loudness, average pitch, pitch range, speaking rate and proportion of pauses.

13. A system for training a neural network (M_{y}), the system comprising a processing device configured to:
receive:
a training vector representation of the emotion associated with the vocal sample (x);
a training vector representation of an emotion prediction associated with a counterfactual synthetic vocal sample (\tilde{x}^{γ}), the counterfactual synthetic vocal sample (\tilde{x}^{γ}) associated with the vocal sample (x) and an alternate emotion (γ) different from the emotion;
training numeric cue difference information associated with the vocal sample (x) and the counterfactual synthetic vocal sample (\tilde{x}^{γ}); and
a reference emotion associated with the vocal sample (x);
generate an emotion prediction associated with the vocal sample (x) based on the training numeric cue difference information, the training vector representation of the emotion associated with the vocal sample (x) and the training vector representation of the emotion prediction associated with the counterfactual synthetic vocal sample (\tilde{x}^{γ}) using the neural network;
calculate a classification loss value based on differences between the emotion prediction and the reference emotion; and
update the neural network (M_{y}) to minimise the classification loss value.

14. The system as claimed in claim 13, wherein the processing device is configured to calculate attribution explanation information (ŵc^{yγ}) with layer-wise relevance propagation of the neural network, the attribution explanation information (ŵc^{yγ}) associated with relative importance of the vocal cue information in prediction of the emotion

15. A system for training a neural network (Mᵣ), the system comprising a processing device configured to:
receive:
a training vector representation of the emotion associated with the vocal sample (x);
a training vector representation of an emotion prediction associated with a counterfactual synthetic vocal sample (\tilde{x}^{γ}), the counterfactual synthetic vocal sample (\tilde{x}^{γ}) associated with the vocal sample (x) and an alternate emotion (γ) different from the emotion;
training numeric cue difference information associated with the vocal sample (x) and the counterfactual synthetic vocal sample (\tilde{x}^{γ});
training attribution explanation information associated with relative importance of the vocal cue information (ĉ^{y}, ĉ^{γ}) in prediction of the emotion; and
reference cue difference relations information (r_{w}^{yγ}) associated with the vocal sample (x) and the counterfactual synthetic vocal sample (\tilde{x}^{γ});
generate cue difference relations information based on the training attribution information, the training numeric cue differences, the training vector representation of the initial prediction and the training vector representation of the emotion prediction associated with the counterfactual synthetic vocal sample (\tilde{x}^{γ}) using the neural network (Mᵣ);
calculate a classification loss value based on differences between the cue difference relations information and the reference cue difference relations information (r_{w}^{yγ}); and
update the neural network (Mᵣ) to minimise the classification loss value.

16. The system as claimed in claim 13, wherein the vocal cue information is associated with one or more of a group consisting of: shrillness, loudness, average pitch, pitch range, speaking rate and proportion of pauses.
